(19) United States
(12) Patent Application Publication
(10) Pub. No.: US 2015/0015931 A1
(43) Pub. Date: Jan. 15, 2015

(54) ELECTROWETTING FLUIDS

(71) Applicant: Merck Patent GmbH, Darmstadt (DE)

(72) Inventors: Louise Diane Farrand, Dorset (GB); Nathan Smith, Southampton (GB); Roshan Kumar, Bracknell (GB); Anthony Lawrence, Manchester (GB)

(73) Assignee: Merck Patent GmbH, Darmstadt (DE)

(21) Appl. No.: 14/381,125

(22) PCT Filed: Feb. 12, 2013
(86) PCT No.: PCT/EP2013/000409

§ 371 Date: Aug. 26, 2014

(30) Foreign Application Priority Data
Mar. 2, 2012 (EP) 12001447.7

(51) Int. Cl. G02B 26/00; G02B 1/06

(52) U.S. Cl. CPC G02B 26/005; G02B 1/06
USPC 359/290; 252/500; 534/561; 534/560

(57) ABSTRACT

This invention relates to electrowetting fluids, the use of these fluids for the preparation of an electrowetting displays devices, and electrowetting display devices comprising such fluids.

This invention relates to an electrowetting fluid, the use of such electrowetting fluid for the preparation of an electrowetting display device, and electrowetting display devices comprising such fluids.

Electrowetting displays (EWD) offer a new route to e-paper that combines video rate response times with a reflective colour display that can be read in bright sunlight, and show low power consumption relative to a typical LCD display. Electrowetting (ew) is a physical process where the wetting properties of a liquid droplet are modified by the presence of an electric field. This effect can be used to manipulate the position of a dyed fluid within a pixel. For example, a dye dissolved in a nonpolar (hydrophobic) solvent can be mixed with a clear colourless polar solvent (hydrophilic), and when the resultant biphasic mixture is placed on a suitable electrowetting surface, for example a highly hydrophobic dielectric layer, an optical effect can be achieved. When the sample is at rest, the (coloured) non-polar phase will wet the hydrophobic surface, and spread across the pixel. To the observer, the pixel would appear coloured. When a voltage is applied, the hydrophobicity of the surface alters, and the surface interactions between the polar phase and the dielectric layer are no longer unfavourable. The polar phase wets the surface, and the coloured non-polar phase is thus driven to a contracted state, for example in one corner of the pixel. To the observer, the pixel would now appear transparent. The invention of electrowetting fast switching displays was reported in Nature (R. A. Hayes, B. J. Feenstra, Nature 425, 383 (2003)). Electrowetting displays are also described in WO 2005/098524, WO 2010/031860, and WO 2011/075720.

The colour properties of the non-polar phase will be dictated by the dye chromophores present in the non-polar phase, and the cell architecture. Since the observed effect is based on surface interactions, there is an advantage to decreasing the cell gap as much as possible to maximise the effect of the surface on the material layer. Typically, if the material layer is too thick, the surface effects will be lessened, and higher voltages will be required to drive the display. However, thinner material layers provide a challenge with regards to achieving strong colour saturation, as the thinner the layer, the lower the absorption of the layer. For EWD, there is a requirement for dyed non-polar solutions with high colour intensity. Furthermore, there is a desire for electrowetting display materials with improved colour tuning, for example to match a company logo colour, to enhance colour gamut, or to improve contrast ratio. Therefore, the object of this invention is to provide new electrowetting display materials.

This object is solved by an electrowetting fluid according to claim 1, by the use of such electrowetting fluid for the preparation of an electrowetting display device and by an electrowetting display device comprising such electrowetting fluid. The present invention also provides new dyes and dye mixtures especially for use in EWD with high absorbance and increased solubility in non-polar solvents. In particular, the present invention provides a non-polar black solution with strong colour intensity that still appears black in a thin cell. The new non-polar black solution shows a broad spectral absorbance from 380-730 nm by using a combination of dyes.

Advantageously, dye mixtures utilising the same chromophore but with variation of the solubilising groups are used. This gives hugely improved solubility in non-polar solvents. Surprisingly, when a mixture of the same chromophore but with different long hydrocarbon groups to increase solubility is used, solubility of up to 15% or of even up to over 17% is achieved. Especially, combinations of dyes are used to achieve a neutral black oil with high absorbance and solubility.

New dyes have improved solubility in non-polar solvents and hence absorbance of the resultant solution. The multi-component dye concept further increases the solubility to enable a highly absorbing material suitable for use in the non-polar phase of EWD. By mixing dyes of identical chromophore, but with altered surrounding structure, the overall solubility of the dye chromophore is increased, and higher absorbance values can be achieved. By adding dyes with similar chromophore/altered surrounding structure, a multi-component dye system results in enhanced solubility and absorbance. One advantage is that a mixture of homologues can be prepared in a one pot procedure, reducing cost of preparing individual dyes.

The function of the dye is to colour the electrowetting fluid. The dye consists of a chromophore, optional linker groups (spacers), and optional groups to modify physical properties (like solubility, light fastness, etc.) and optionally charged group(s). Careful design of the dye structure and using a mixture of homologues can result in increased solubility:

The chromophoric group preferably comprises of conjugated aromatic (including heteroaromatic) and/or multiple bonds including: azo (including monoazo, disazo, trisazo linked azos etc), metallised azo, anthraquinone, pyrroline, phthalocyanine, polymethine, aryl-carbonium, triphendioxazine, diarylmethane, triarylmethane, anthraquinone, phthalocyanine, methine, polymethine, indoaniline, indophenol, stilbene, squarilium, aminoketone, xanthene, fluorone, acridene, quinolene, thiazole, azine, induline, nigrosine, oxazine, thiazine, indigoid, quinonioid, quinacridone, lactone, benzodifuranone, flavonol, chalone, polyene, chroman, nitro, naphtholactam, formazene or indolene group or a combination of two or more such groups. Preferred chromophoric groups are azo groups (especially monoazo, and disazo) and anthraquinone groups.

A dye may contain a single chromophore, for example with bright yellow, magenta or cyan colours and self shade blacks. However, it may also contain mixed covalently attached chromophores for example to obtain a black colour, by covalently attached brown and blue or yellow, magenta and cyan. Green can be obtained by yellow and cyan etc. Extended conjugated chromophores can also be used to obtain some shades. For example, di- and tris azo compounds can be used to obtain blacks and other duller shades (navy blue, brown, olive green, etc).

Mixtures of dyes can also be used to obtain the correct electrowetting fluid shade; for example a black from single component mixtures of brown and blue or yellow, magenta and cyan dyes. Similarly shades can be tuned by for example by adding small quantities of separate dyes to modify the colour of the electrowetting fluid (e.g. 95% yellow and 5% cyan to get a greener yellow shade).

A particular focus is the use of mixtures of one chromophore. The solubilising groups on the chromophore are preferably hydrocarbon chains consisting of 4 or more carbons. These chains can be straight chain, branched chain, contain isomers such diastereoisomers, be optionally substituted with O, S, N, F. Preferably a mixture of homologues comprising hydrocarbon chains consisting of 8-20 carbons is used to give highest solubility. One advantage is that a mixture of homologues can be prepared in a one pot procedure, reducing cost of preparing individual dyes.

Preferably, the electrowetting fluid of the invention comprises at least one dye according to Formula I, Formula II, Formula III, Formula IV or Formula V

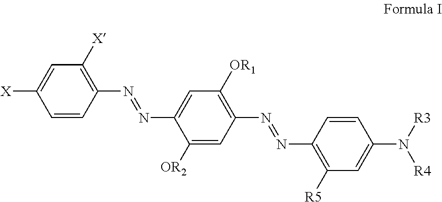

wherein
X and X′ are independently of one another H or an electron-withdrawing group;
R₁ and R₂ are independently of one another groups are linear or branched, substituted or unsubstituted alkyl groups where one or more non-adjacent carbon atoms may be replaced by O, S and/or N, preferably C8-C20;
R3 and R4 are independently of one another groups are linear or branched, substituted or unsubstituted alkyl groups where one or more non-adjacent carbon atoms may be replaced by O, S and/or N, preferably C8-C20;
R5 is a methyl or methoxy group;
and the dye comprises at least one electron-withdrawing group;

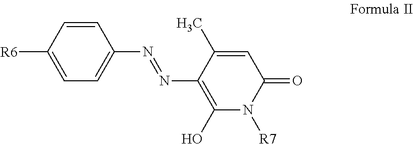

### Wherein

R₆ and R₇ are independently of one another groups are linear or branched, substituted or unsubstituted alkyl groups where one or more non-adjacent carbon atoms may be replaced by O, S and/or N, preferably C8-C20;

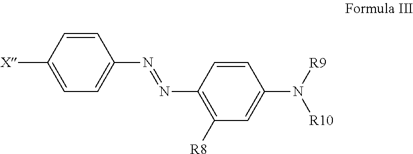

wherein
X″ is an electron-withdrawing group;
R₈ is a methyl or methoxy group;
R₉ and R₁₀ are independently of one another groups are linear or branched, substituted or unsubstituted alkyl groups where one or more non-adjacent carbon atoms may be replaced by O, S and/or N; preferably C8-C20;

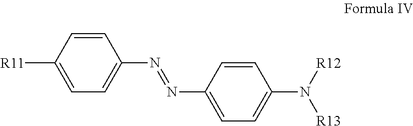

wherein
R₁₂ and R₁₃ are independently of one another groups are linear or branched, substituted or unsubstituted alkyl groups where one or more non-adjacent carbon atoms may be replaced by O, S and/or N; preferably C8-C20;
R₁₁ is an alkyl or alkoxy group with at least 3 carbon atoms;

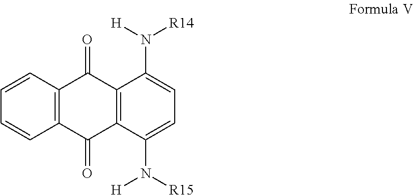

wherein
R₁₄ and R₁₅ are independently of one another groups are linear or branched, substituted or unsubstituted alkyl groups where one or more non-adjacent carbon atoms may be replaced by O, S and/or N; preferably C8-C20;

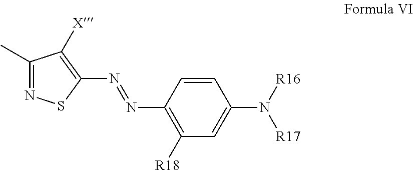

wherein
X′″ is an electron-withdrawing group;
R₁₆ and R₁₇ are independently of one another groups are linear or branched, substituted or unsubstituted alkyl groups where one or more non-adjacent carbon atoms may be replaced by O, S and/or N, preferably C8-C20.
R₁₈ is NHCOR with R=linear or branched C1-C10 alkyl groups, preferably NHCOCH₃.

The term “electron-withdrawing group” is well known in the art and refers to the tendency of a substituent to attract valence electrons from neighbouring atoms; in other words the substituent is electronegative with respect to neighbouring atoms. Examples of electron-withdrawing groups include NO₂, CN, halogen, acyl, trifluoromethoxy, trifluoromethyl, SO₂F, and CO₂R, SO₂R, SO₂NRR or SO₂NHR, with R being independently linear or branched alkyl, preferably C1-C4 alkyl. Preferred electron-withdrawing groups are NO₂, CN, Br, Cl, SO₂NRR or SO₂NHR.

Preferably, dyes of Formula I with linear or branched C8-C20 alkyl groups are used, especially those with two electron-withdrawing groups, especially with two NO₂ and/or CN groups.

Also preferred are dyes of Formula II with linear or branched C8-C20 alkyl groups, especially those with additional NO₂ and/or CN groups, in particular dyes corresponding to Formula IIa

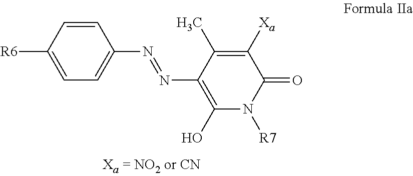

It is most advantageous to use mixtures of homologue dyes comprising dyes with different linear or branched alkyl groups, preferably with C8-C20 groups; for example mixtures of dyes with 2-ethylhexyl, n-octyl, 3,5,5-trimethylhexyl, n-decyl, n-undecyl, n-dodecyl, tetradecyl, and/or pentadecyl groups. Especially useful are such mixtures of the preferred dyes described in the foregoing.

Especially the dyes listed in the following tables may be used.

TABLE 1
Blue/Black Dyes

| | | | Saturation |
|---|---|---|---|
| Dye | | Compound | wt % in |
| No. | Structure | Data | decane |
| Dye 1a | 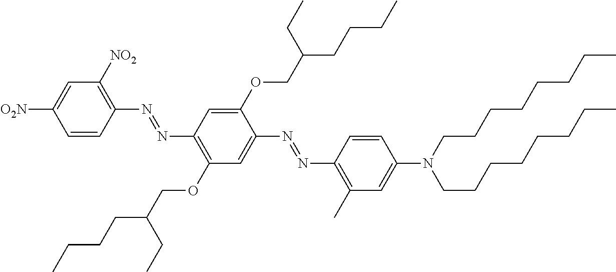 [SMILES: CCCCCCCCN(CCCCCCCC)c1ccc(/N=N/c2cc(OCC(CC)CCCC)c(/N=N/c3ccc([N+](=O)[O-])cc3[N+](=O)[O-])cc2OCC(CC)CCCC)c(C)c1] | UV-vis λₘₐₓ 600 nm, εₘₐₓ 44,500 HBW 151 nm (hexane) Mp: 91-94° C. | 100 |
| Dye 1b | 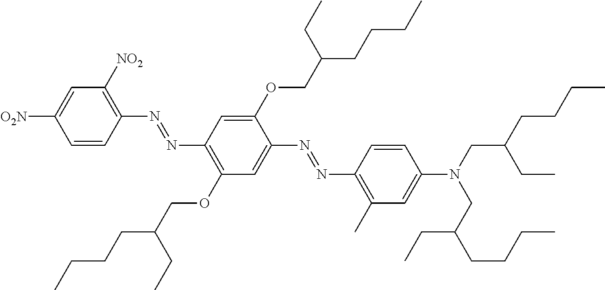 [SMILES: CCCCC(CC)COc1cc(/N=N/c2ccc([N+](=O)[O-])cc2[N+](=O)[O-])c(OCC(CC)CCCC)cc1/N=N/c1ccc(N(CC(CC)CCCC)CC(CC)CCCC)cc1C] | UV-vis λₘₐₓ 601 nm, εₘₐₓ 45,500 HBW 150 nm (hexane) Mp: 93-96° C. | 17.19 |
| Dye 1c | 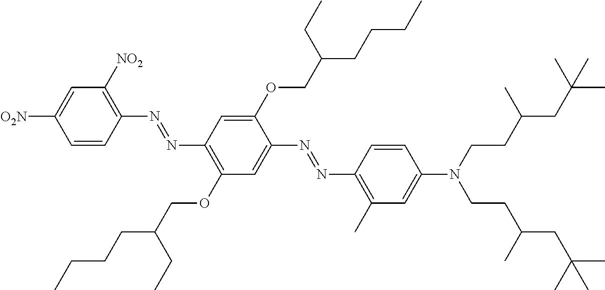 [SMILES: CCCCC(CC)COc1cc(/N=N/c2ccc([N+](=O)[O-])cc2[N+](=O)[O-])c(OCC(CC)CCCC)cc1/N=N/c1ccc(N(CCC(C)CC(C)(C)C)CCC(C)CC(C)(C)C)cc1C] | UV-vis λₘₐₓ 598 nm, εₘₐₓ 43,500 HBW 151 nm (hexane) Mp: 103-105° C. | 3.53 |
| Dye 1d | 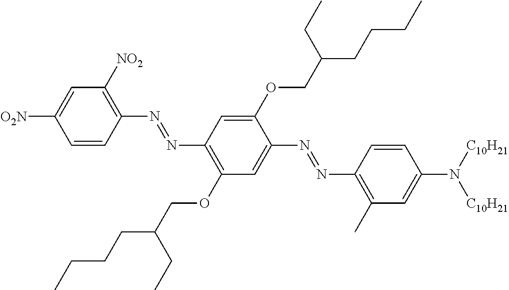 | UV-vis λₘₐₓ 598 nm, εₘₐₓ 44,000 HBW 151 nm (hexane) Mp: 84-86° C. | 2.39 |
| Dye 1e | 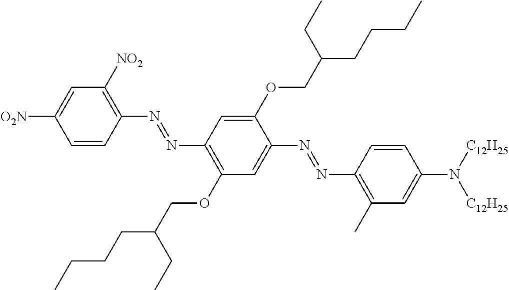 | UV-vis λₘₐₓ 598 nm, εₘₐₓ 45,000 HBW 149 nm (hexane) Mp: 84-87° C. | 5.17 |
| Dye 1f | 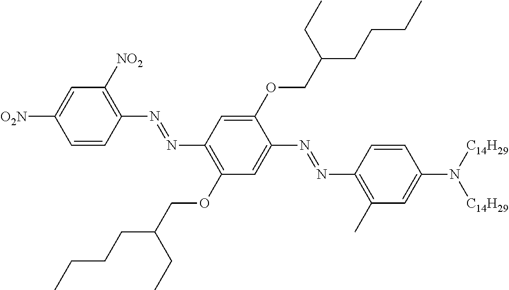 | UV-vis λₘₐₓ 599 nm, εₘₐₓ 44,750 HBW 149 nm (hexane) Mp: 73-75° C. | 15.2 |
| Dye 1g | 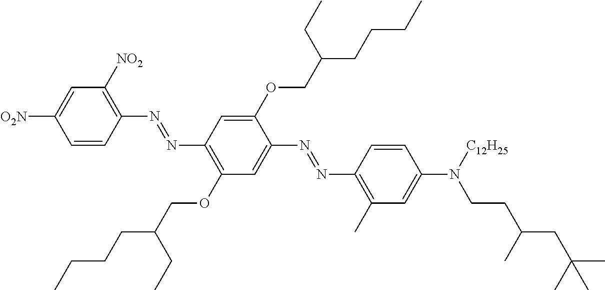 | UV-vis λₘₐₓ 600 nm, εₘₐₓ 45,000 HBW 151 nm (hexane) Mp: 69-71° C. | 16.67 |
| Dye 1h | 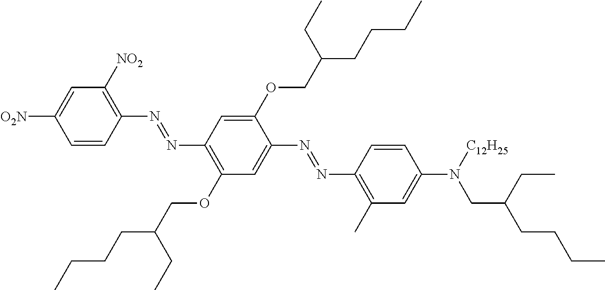 | UV-vis λₘₐₓ 600 nm, εₘₐₓ 42,000 HBW 151 nm (hexane) Mp: oily semi- solid | |
| Dye 2 | 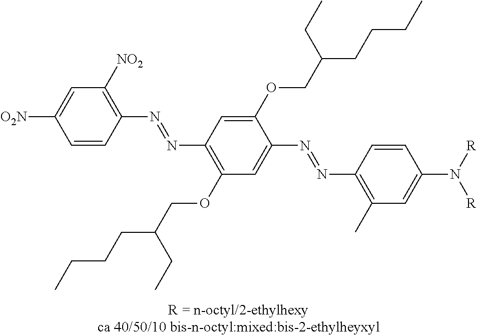 | UV-vis λₘₐₓ 599 nm, εₘₐₓ 40,000 HBW 151 nm (hexane) Mp: amorphous solid | 12.934 |
| Dye 3 | 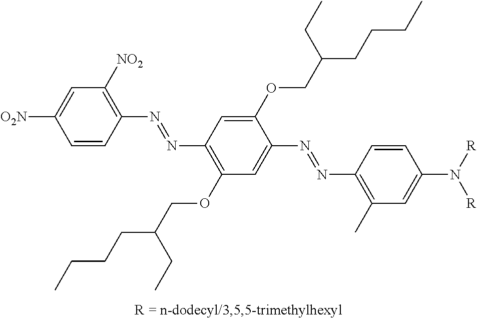 | UV-vis λₘₐₓ 599 nm, εₘₐₓ 38,500 HBW 156 nm (hexane) Mp: oil | 16.992 |
| Dye 4 | 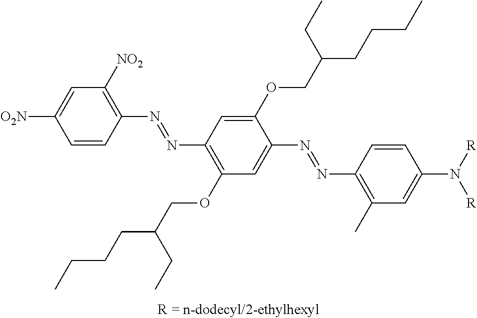 | UV-vis λₘₐₓ 598 nm, εₘₐₓ 34,000 HBW 151 nm (hexane) Mp: amorphous solid | 17.147 |
| Dye 5 | 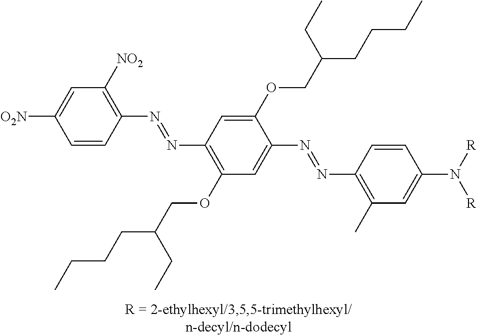 | UV-vis λₘₐₓ 598 nm, εₘₐₓ 40,500 HBW 154 nm (hexane) Mp: oil | 16.233 |
| Dye 6 | 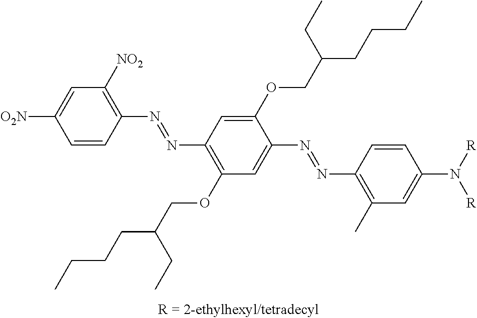 | UV-vis λₘₐₓ 598 nm, εₘₐₓ 34,000 HBW 167 nm (hexane) Mp: oil | 15.977 |
| Dye 7 | 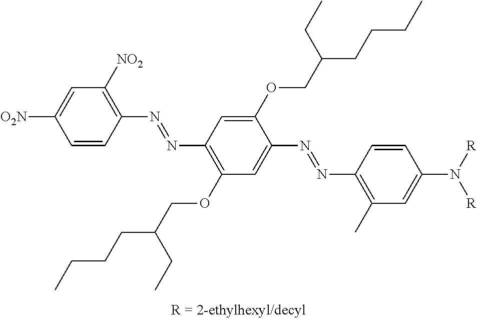 | UV-vis λₘₐₓ 599 nm, εₘₐₓ 45,000 HBW 153 nm (hexane) Mp: amorphous solid | 15.922 |

TABLE 2
Cyan Dyes

| | | | Saturation |
|---|---|---|---|
| | | | wt % in |
| Dye No. | Structure | Compound Data | decane |
| Dye 8 | 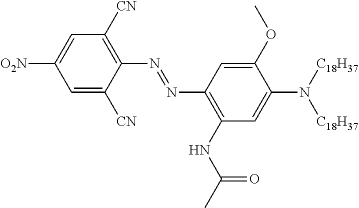 | UV-vis λₘₐₓ 642 nm, εₘₐₓ 103,000 HBW 44 nm (hexane) λₘₐₓ 595 nm, εₘₐₓ 48,500 HBW 77 nm (hexane) Mp: 95-97° C. | 0.003 |
| Dye 9 | 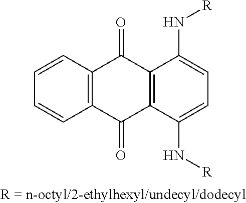 | UV-vis λₘₐₓ 645 nm, εₘₐₓ 15,000 (hexane) λₘₐₓ 595 nm, εₘₐₓ 13,250 (hexane) Mp: amorphous solid | 4.2 |
| Dye 10 | 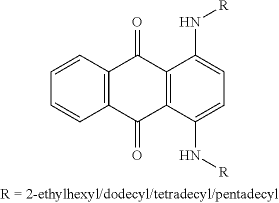 | UV-vis λₘₐₓ 645 nm, εₘₐₓ 15,750 (hexane) λₘₐₓ 596 nm, εₘₐₓ 14,000 (hexane) Mp: amorphous solid | 4.557 |

TABLE 3
Magenta Dyes

| | | | Saturation |
|---|---|---|---|
| | | | wt % in |
| Dye No. | Structure | Compound Data | decane |
| Dye 11 | 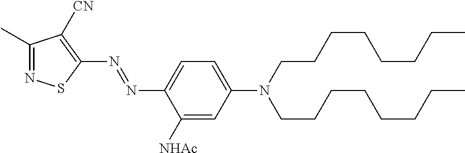 [SMILES: CCCCCCCCN(CCCCCCCC)c1ccc(/N=N/c2snc(C)c2C#N)c(NC(C)=O)c1] | UV-vis λₘₐₓ 536 nm, εₘₐₓ 61,750 HBW 71 nm (hexane) λₘₐₓ 548 nm, εₘₐₓ 61,000 HBW 77 nm (EtOAc) Mp: 110-111° C. | 0.19 |

TABLE 4
Yellow Dyes

| | | | Saturation |
|---|---|---|---|
| | | | wt % in |
| Dye No. | Structure | Compound Data | decane |
| Dye 12 | 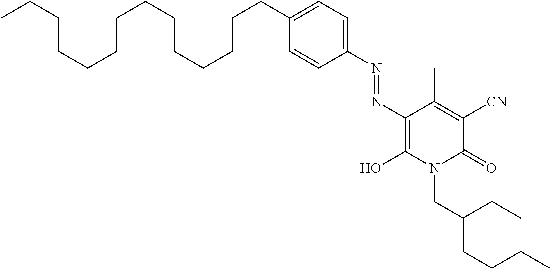 [SMILES: CCCCCCCCCCCCCCc1ccc(/N=N/c2c(C)c(C#N)c(=O)n(CC(CC)CCCC)c2O)cc1] | UV-vis λₘₐₓ 436 nm, εₘₐₓ 45,000 HBW 73 nm (hexane) HPLC (420 nm): >99.5% Mp: 73-75° C. | 1.03 |
| Dye 13 | 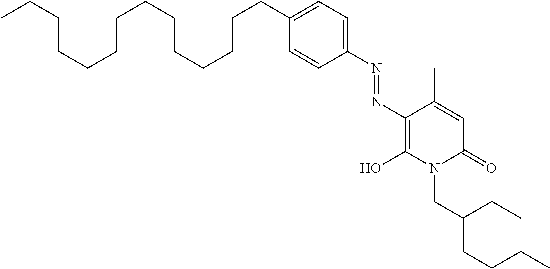 [SMILES: CCCCCCCCCCCCCCc1ccc(/N=N/c2c(C)cc(=O)n(CC(CC)CCCC)c2O)cc1] | UV-vis λₘₐₓ 416 nm, εₘₐₓ 38,000 HBW 67 nm (hexane) Mp: 63-65° C. | 3.72 |
| Dye 14 | 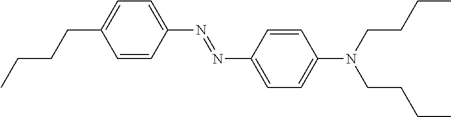 [SMILES: CCCCc1ccc(/N=N/c2ccc(N(CCCC)CCCC)cc2)cc1] | UV-vis λₘₐₓ 407 nm, εₘₐₓ 38,000 HBW 68 nm (hexane) Mp: Oil at room temp | 9.95 |
| Dye 15 | 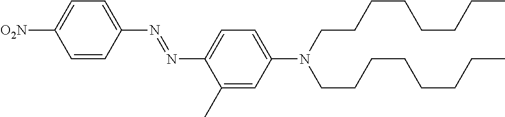 [SMILES: CCCCCCCCN(CCCCCCCC)c1ccc(/N=N/c2ccc([N+](=O)[O-])cc2)c(C)c1] | UV-vis λₘₐₓ 470 nm, εₘₐₓ 36,000 HBW 93 nm (hexane) Mp: 44-46° C. | 10.50 |

Preferably, Dyes 2-7, 9 and 10 can be used showing increased solubility, especially Dyes 2-7.

In another preferred variant of the invention mixtures of dyes may be used, for example mixtures of Dyes 1-7 with dyes of Tables 2-4.

The following schemes show by way of example for Dye 1a, Dye 13, Dye 15, Dye 14, Dye 9, and Dye 11 the synthesis of dyes of the invention, especially for dyes of Formulas I to VI which can be carried out by processes and under conditions known to the person skilled in the art; further details are given in the examples:

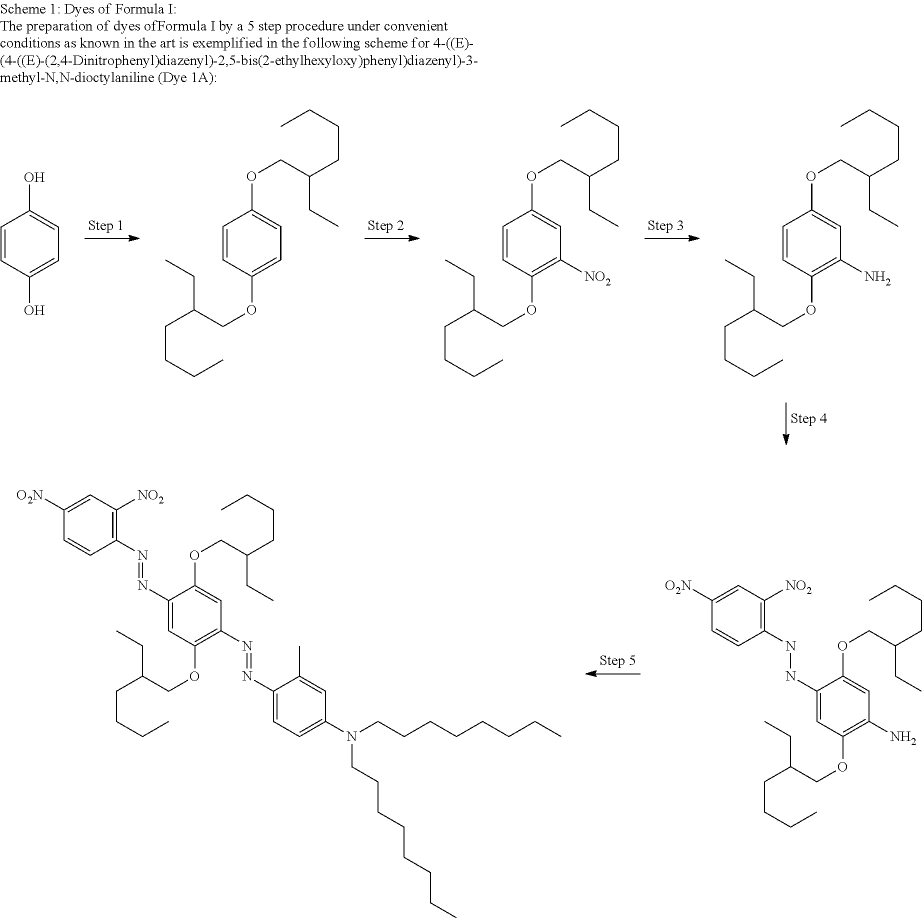 [SMILES: Oc1ccc(O)cc1 ; CCCCC(CC)COc1ccc(OCC(CC)CCCC)cc1 ; CCCCC(CC)COc1ccc(OCC(CC)CCCC)c([N+](=O)[O-])c1 ; CCCCC(CC)COc1ccc(OCC(CC)CCCC)c(N)c1 ; CCCCCCCCN(CCCCCCCC)c1ccc(/N=N/c2cc(OCC(CC)CCCC)c(/N=N/c3ccc([N+](=O)[O-])cc3[N+](=O)[O-])cc2OCC(CC)CCCC)c(C)c1 ; CCCCC(CC)COc1cc(NNc2ccc([N+](=O)[O-])cc2[N+](=O)[O-])c(OCC(CC)CCCC)cc1N]

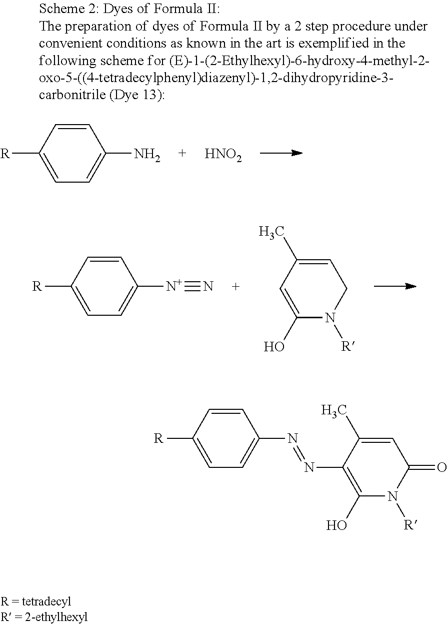

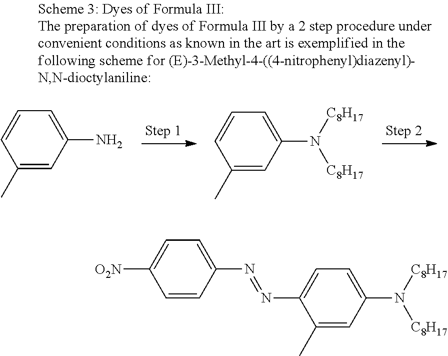

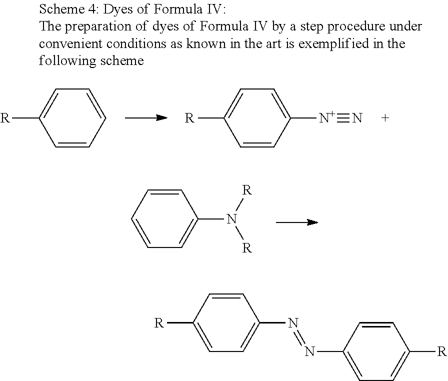

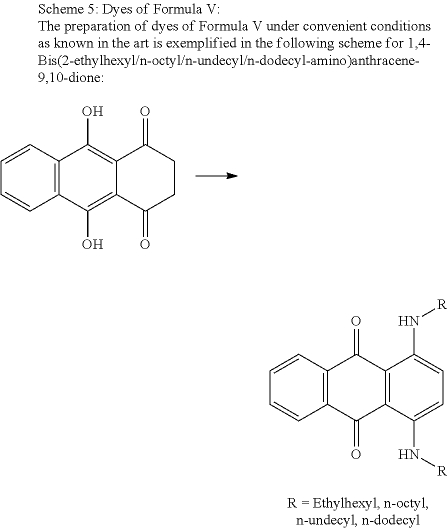

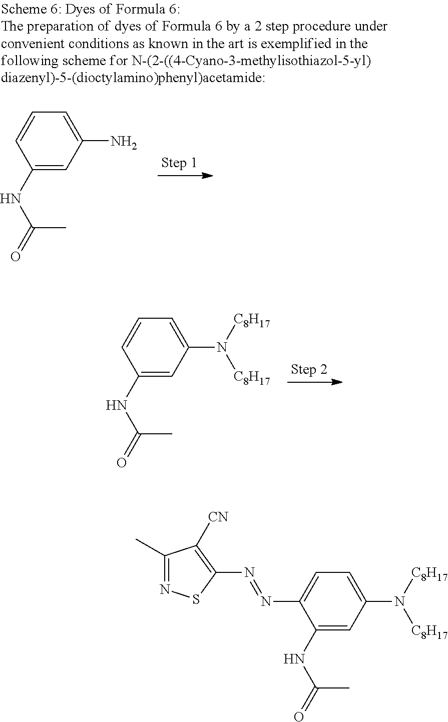

The preparation of further dyes can be carried out analogously to the illustrative reactions shown above and in the examples.

The electrowetting fluids of the invention usually comprise a non-polar solvent or a mixture of non-polar solvents and are primarily designed for use as the non-polar phase in electrowetting display devices. So, further subjects of the invention are electrowetting display devices comprising such fluids.

A typical electrowetting display device preferably consists of the dyes in a low polar or non-polar solvent along with additives to improve properties, such as stability and charge. The present electrowetting fluids comprising a non-polar (hydrophobic) solvent or solvent mixture and at least one dye according to the invention can be mixed with a clear colourless polar (hydrophilic) solvent, and the resultant biphasic mixture is placed on a suitable electrowetting surface, for example a highly hydrophobic dielectric layer. The wetting properties of the resultant biphasic mixture can then be modified by the presence of an electric field. This effect can be used to manipulate the position of a dyed fluid within a pixel. Examples of such solvents, additives for electrowetting fluids and electrowetting display devices are well described in the literature, for example in Nature (R. A. Hayes, B. J. Feenstra, Nature 425, 383 (2003)), WO 2005/098524, WO 2010/031860, and WO 2011/075720.

A preferred non-polar solvent choice displays a low dielectric constant (<10, more preferably <5), high volume resistivity (about 10¹⁵ ohm-cm), low viscosity (less than 5 cst), low water solubility, a high boiling point (>80° C.) and a refractive index and density similar to that of the polar phase to be used. Tweaking these variables can be useful in order to change the behaviour of the final application. Preferred solvents are often non-polar hydrocarbon solvents such as the Isopar series (Exxon-Mobil), Norpar, Shell-Sol (Shell), Sol-Trol (Shell), naphtha, and other petroleum solvents, as well as long chain alkanes such as dodecane, tetradecane, decane, nonane or mixtures of these solvents. These tend to be low dielectric, low viscosity, and low density solvents. Especially preferred solvents according to the invention are long chain alkanes such as dodecane, tetradecane, decane, nonane or mixtures of these solvents.

The disclosures in the cited references are expressly also part of the disclosure content of the present patent application. In the claims and the description, the words “comprise/comprises/comprising” and “contain/contains/containing” mean that the listed components are included but that other components are not excluded. All process steps described above and below can be carried out using known techniques and standard equipments which are described in prior art and are well-known to the skilled person. The following examples explain the present invention in greater detail without restricting the scope of protection. In the foregoing and in the following examples, unless otherwise indicated all parts and percentages are by weight.

### EXAMPLES

All chemicals are purchased from Sigma-Aldrich. All chemicals are purchased at the highest grade possible and are used without further purification unless otherwise stated.

The following abbreviations are used:

IMS industrial methylated spirit;

### NMP N-Methylpyrrolidone

### THF Tetrahydrofuran

### DCM Dichloromethane

Mp melting point

### Example 1

### Example 1a

### Dye 1a: 4-((E)-(4-((E)-(2,4-Dinitrophenyl)diazenyl)-2,5-bis(2-ethylhexyloxy)phenyl)diazenyl)-3-methyl-N,N-dioctylaniline

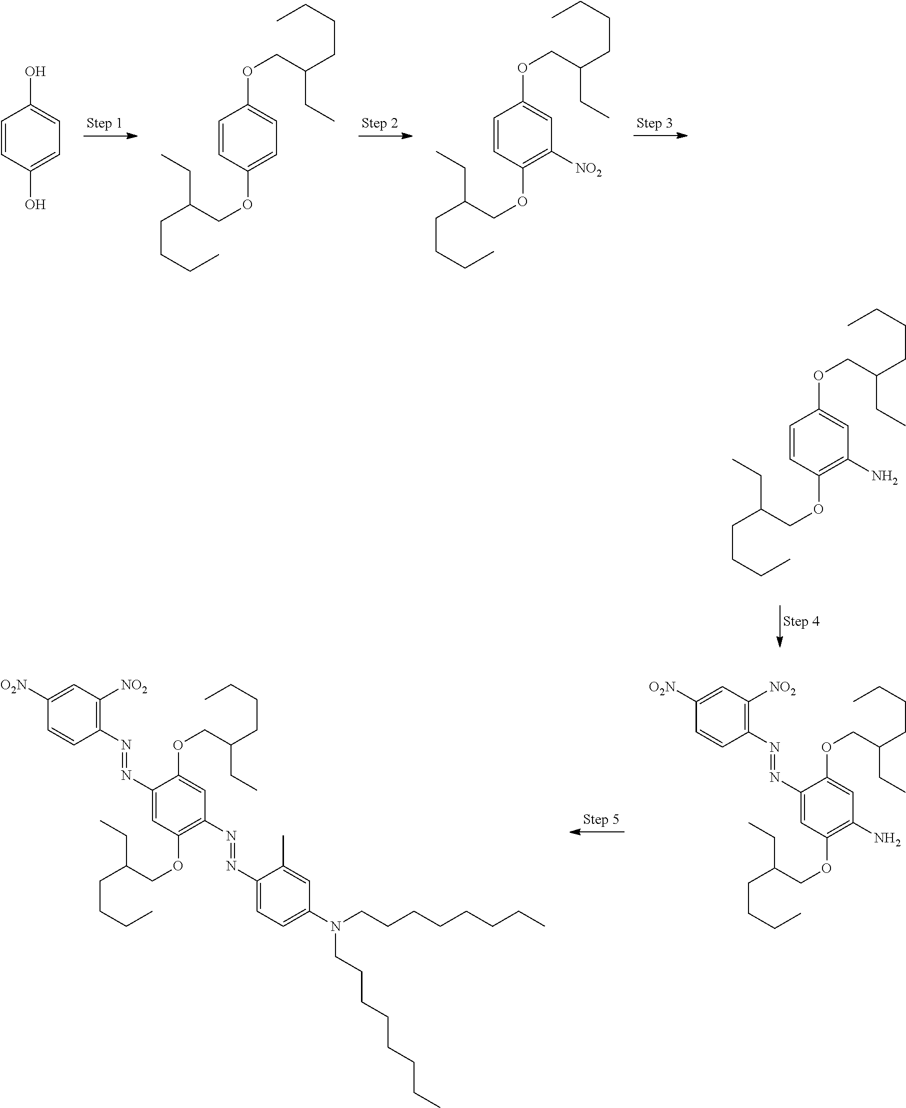 [SMILES: Oc1ccc(O)cc1 ; CCCCC(CC)COc1ccc(OCC(CC)CCCC)cc1 ; CCCCC(CC)COc1ccc(OCC(CC)CCCC)c([N+](=O)[O-])c1 ; CCCCC(CC)COc1ccc(OCC(CC)CCCC)c(N)c1 ; CCCCCCCCN(CCCCCCCC)c1ccc(/N=N/c2cc(OCC(CC)CCCC)c(/N=N/c3ccc([N+](=O)[O-])cc3[N+](=O)[O-])cc2OCC(CC)CCCC)c(C)c1 ; CCCCC(CC)COc1cc(/N=N/c2ccc([N+](=O)[O-])cc2[N+](=O)[O-])c(OCC(CC)CCCC)cc1N]

### Step 1: 1,4-Bis(2-ethylhexyloxy)benzene

Hydroquinone (37.9 g, 0.344 mol) is suspended in industrial methylated spirits (IMS) (310 ml) and 1-bromo-2-ethylhexane (132.7 g, 0.687 mol) is added. A solution of KOH (49.9 g, 0.89 mol) in IMS (250 ml) is added slowly over 1 minute. The mixture is heated at reflux. Further 1-bromo-2-ethylhexane (21.0 g, 0.109 mol) is added and the reaction heated at reflux a further 3 h. The reaction mixture is allowed to cool, is poured into water (1.5 L) and extracted with toluene (500 ml). The organic layer is dried over MgSO₄ then evaporated to yield a pale yellow free-flowing oil. The oil is purified by flash column to give pure 1,4-bis(2-ethylhexyloxy)benzene as a pale yellow oil (73.7 g, 64%).

### Step 2: 1,4-Bis(2-ethylhexyloxy)-2-nitrobenzene

1,4-Bis(2-ethylhexyloxy)benzene (50.2 g, 0.150 mol) is dissolved in chloroform (150 ml) and cooled to 0° C. Nitric acid (70%, 17.0 g, 0.190 mol) is added dropwise at 0-3°. After 60 minutes, water (50 ml) is added and the organic layer separated and dried (MgSO₄). The dried chloroform layer is re-chilled to 0° C. and retreated with 70% nitric acid (6.5 g, 0.075 mol). Water (50 ml) is added, the organic layer separated, washed with 5% sodium bicarbonate solution (50 ml) then dried (MgSO₄) and evaporated to give the title compound as a yellow oil (56.9 g, 100%). The material is used without further purification.

### Step 3: 2,5-Bis(2-ethylhexyloxy)aniline

1,4-Bis(2-ethylhexyloxy)-2-nitrobenzene (11.4 g, 0.03 mol) is dissolved in 2-propanol (100 ml) and degassed under vacuum, purging to nitrogen. 10% (w/w) Pd/C (0.52 g) is added and the mixture heated to 80° C. Water (10 ml) is added, followed by solid ammonium formate (18.9 g, 0.3 mol) in gradual portions over 1 h. After a further 1 h at 80° C., the reaction mixture is allowed to cool then filtered to remove catalyst, to give a colourless solution. The material is used immediately as an isopropanol solution.

### Step 4: 4-((2,4-Dinitrophenyl)diazenyl)-2,5-bis(2-ethylhexyloxy)aniline

2,4-Dinitroaniline (3.7 g, 0.02 mol) is suspended in a mixture of acetic acid (20 ml) and propionic acid (10 ml) and cooled to 3° C. A 3-7° C., 40% (w/w) nitrosyl sulfuric acid in sulfuric acid (6.4 g, 0.02 mol) is added dropwise and stirring continued for 30 minutes to give a pale yellow solution. Crude 2,5-bis(2-ethylhexyloxy)aniline (0.02 mol) solution is diluted with IMS (200 ml) and 10% sulfamic acid solution (20 ml) added, followed by ice (200 g). The above pale yellow diazonium salt solution is slowly added with stirring and a dark oil rapidly separated. The mixture is stirred overnight and the water is decanted off. The crude product (8.3 g) is dissolved in 25/75 dichloromethane/hexane and purified over silica gel, the required product eluting with 50/50 hexane/dichloromethane. Evaporation and trituration with methanol gives 4-((2,4-dinitrophenyl)diazenyl)-2,5-bis(2-ethylhexyloxy)aniline as a violet-blue crystalline solid (4.2 g, 39%).

### Step 5: 4-((E)-(4-((E)-(2,4-Dinitrophenyl)diazenyl)-2,5-bis(2-ethylhexyloxy)phenyl)diazenyl)-3-methyl-N,N-dioctylaniline

4-((2,4-Dinitrophenyl)diazenyl)-2,5-bis(2-ethylhexyloxy)aniline (2.72 g, 5.0 mmol) is dissolved in NMP (50 ml) and to this is added 40% (w/w) nitrosyl sulfuric acid in sulfuric acid (1.9 g, 6.0 mmol). After 30 minutes, the mixture is added to a solution of 3-methyl-N,N-dioctylaniline (1.82 g, 5.5 mmol) and sulfamic acid (0.5 g) in IMS (100 ml). A dark oily solid separated, which solidified on further stirring overnight. The pure title compound is acquired as black crystals after purification over silica gel, eluting with dichloromethane, then recrystallisation from dichloromethane/IMS (2.7 g, 60%); mp: 91-94° C.; λₘₐₓ (hexane) 600 nm (44,500), FWHM 151 nm; ¹H NMR gave expected signals.

### Example 1 b

### Dye1b: 4-((E)-(4-((E)-(2,4-Dinitrophenyl)diazenyl)-2,5-bis(2-ethylhexyloxy)phenyl)diazenyl)-3-methyl-N,N-di-(2-ethylhexyl)aniline

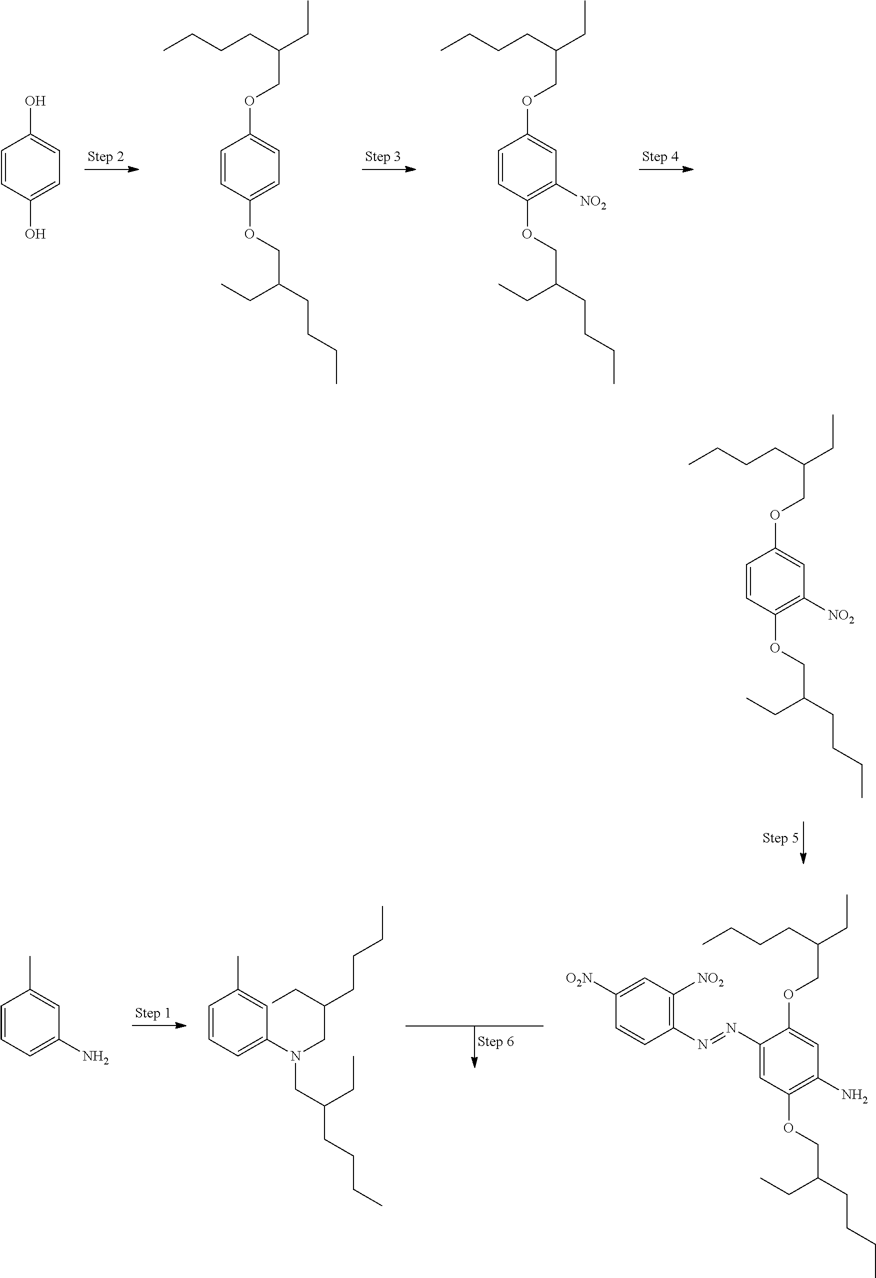

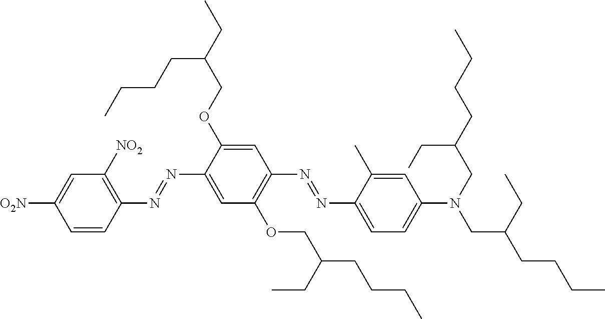 [SMILES: CCCCC(CC)COc1cc(/N=N/c2ccc([N+](=O)[O-])cc2[N+](=O)[O-])c(OCC(CC)CCCC)cc1/N=N/c1ccc(N(CC(CC)CCCC)CC(CC)CCCC)cc1C]

### Step 1: N,N-di-(2-ethylhexyl)-m-toluidine

A mixture of m-toluidine (10.7 g, 0.10 mol), 1-bromo-2-ethylhexane (57.9 g, 0.30 mol), 1-methyl-2-pyrrolidone (50 ml) and sodium bicarbonate (21.0 g, 0.25 mol) is heated at 100° C. for 48 h, then at 140° C. for 72 h. The reaction is allowed to cool, poured into water (250 ml) then extracted with hexane (2×250 ml). The combined organic layers are dried (MgSO₄) and evaporated to give a brown oil. The material was purified over silica gel, eluting with hexane to afford the title compound as a colourless oil (26.1 g, 78%).

### Step 2: 1,4-Bis(2-ethylhexyloxy)benzene

Hydroquinone (37.9 g, 0.344 mol) is suspended in IMS (310 ml) and 1-bromo-2-ethylhexane (132.7 g, 0.687 mol) is added. A solution of KOH (49.9 g, 0.89 mol) in IMS (250 ml) is added slowly over 1 minute. The mixture is heated at reflux for 16 h. The reaction mixture is allowed to cool, poured into water (1.5 L) and then extracted with toluene (500 ml). The organic layer is dried over MgSO₄ then evaporated to yield a pale yellow free-flowing oil. The oil is flashed through silica gel, eluting with hexane, then 50/50 dichloromethane/hexane to give two product fractions. The initial fraction (35.3 g) contained 1-bromo-2-ethylhexane. The second fraction is evaporated to give pure 1,4-bis(2-ethylhexyloxy)benzene as a pale yellow oil (48.4 g, 42%). The initial fraction is further purified by bulb to bulb distillation to give additional pure 1,4-bis(2-ethylhexyloxy)benzene as a pale yellow oil (25.3 g, 22%).

### Step 3: 1,4-Bis(2-ethylhexyloxy)-2-nitrobenzene

1,4-Bis(2-ethylhexyloxy)benzene (50.2 g, 0.150 mol) is dissolved in chloroform (150 ml) and cooled to 0° C. Nitric acid (70%, 17.0 g, 0.190 mol) is added dropwise. Water (50 ml) is added and the organic layer separated and dried (MgSO₄) and evaporated to give the title compound as a yellow oil (56.9 g, 100%), which was >98% pure by HPLC. The material was used without further purification.

### Step 4: 2,5-Bis(2-ethylhexyloxy)aniline

1,4-Bis(2-ethylhexyloxy)-2-nitrobenzene (11.4 g, 0.03 mol) is dissolved in 2-propanol (100 ml) and degassed under vacuum, purging to nitrogen. 10% (w/w) Pd/C (0.52 g) is added and the mixture heated to 80° C. Water (10 ml) is added, followed by solid ammonium formate (18.9 g, 0.3 mol) in gradual portions over 1 h. After a further 1 h at 80° C., the reaction mixture is allowed to cool then filtered to remove catalyst, to give a colourless solution which darkened rapidly on standing. The material was used immediately as an isopropanol solution.

### Step 5: 4-((2,4-Dinitrophenyl)diazenyl)-2,5-bis(2-ethylhexyloxy)aniline

2,4-Dinitroaniline (3.7 g, 0.02 mol) is suspended in a mixture of acetic acid (20 ml) and propionic acid (10 ml) and cooled to 3° C. At 3-7° C., 40% (w/w) nitrosyl sulfuric acid in sulfuric acid (6.4 g, 0.02 mol) is added dropwise. Crude 2,5-bis(2-ethylhexyloxy)aniline (0.02 mol) solution is diluted with IMS (200 ml) and 10% sulfamic acid solution (20 ml) added, followed by ice (200 g). The above pale yellow diazonium salt solution was slowly added with stirring and a dark oil rapidly separated. The mixture is stirred overnight and the water is decanted off. The crude product (8.3 g) is dissolved in 25/75 dichloromethane/hexane and purified over silica gel. Evaporation and trituration with methanol gave 4-((2,4-dinitrophenyl)diazenyl)-2,5-bis(2-ethylhexyloxy)aniline as a violet-blue crystalline solid (4.2 g, 39%).

### Step 6: 4-((E)-(4-((E)-(2,4-Dinitrophenyl)diazenyl)-2,5-bis(2-ethylhexyloxy)phenyl)diazenyl)-3-methyl-N,N-di-(2-ethylhexyl)aniline

4-((2,4-Dinitrophenyl)diazenyl)-2,5-bis(2-ethylhexyloxy)aniline (7.5 g, 13.7 mmol) is dissolved in NMP (135 ml) and to this is added 40% (w/w) nitrosyl sulfuric acid in sulfuric acid (6.2 g, 19.5 mmol) allowing the mixture to exotherm. After 30 minutes, the diazonium salt solution is added slowly to a solution of N,N-di-(2-ethylhexyl)-m-toluidine (4.7 g, 14.3 mmol) and 10% sulfamic acid (20 ml) in acetone (200 ml) and ice (200 g). After stirring overnight, the solid is filtered off, washed with water, re-slurried in methanol (200 ml), filtered off and pulled dry. The filtered solid is dissolved in hexane and purified over silica gel, eluting with 50/50 dichloromethane/hexane. The enriched fractions are combined, concentrated in vacuo and the resultant black solid recrystallised from dichloromethane/methanol, to give the title compound, after drying, as a black powder (6.7 g, 58%); m.p. 93-96° C.; λₘₐₓ (hexane) 601 nm (45,500), FWHM 150 nm; ¹H nmr (300 MHz, CDC₃) δ0.85-1.02 (24H, m), 1.20-1.70 (32H, m), 1.85 (4H, m), 2.75 (3H, s), 3.36 (4H, m), 4.03 (2H, m), 4.12 (2H, d, J 6.5), 6.58 (2H, m), 7.36 (1H, s), 7.41 (1H, s), 7.81 (1H, d, J 9.0), 7.89 (1H, d, J 9.0), 8.48 (1H, dd, J 2.0, J 9.0), 8.78 (1H, d, J 2.0).

### Example 1c

### Dye1c: 4-((E)-(4-((E)-(2,4-Dinitrophenyl)diazenyl)-2,5-bis(2-ethylhexyloxy)phenyl)diazenyl)-3-methyl-N,N-d i-(3,5,5-trimethylhexyl)aniline

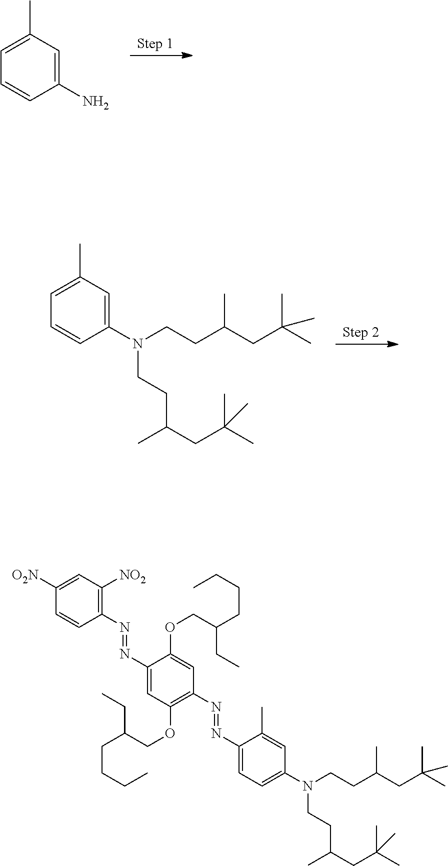

### Step 1: N,N-d i-(3,5,5-trimethylhexyl)-m-toluidine

A mixture of m-toluidine (10.7 g, 0.10 mol), 1-bromo-3,5,5-trimethylhexane (54.5 g, 0.25 mol), 1-methyl-2-pyrrolidone (50 ml) and sodium bicarbonate (21.0 g, 0.25 mol) is heated at 100° C. for 72 h. The reaction is allowed to cool then partitioned between water (250 ml) and hexane (250 ml). The aqueous layer is extracted with further hexane (150 ml) and the combined organic layers were dried (MgSO₄) and evaporated to give a brown oil. Acetic anhydride (3 ml) is added and the mixture allowed to stand for 16 h, before using directly without further purification, assuming 0.09 mol product.

### Step 2: 4-((E)-(4-((E)-(2,4-Dinitrophenyl)diazenyl)-2,5-bis(2-ethylhexyloxy)phenyl)diazenyl)-3-methyl-N,N-d i-(3,5,5,trimethylhexyl)aniline

4-((2,4-Dinitrophenyl)diazenyl)-2,5-bis(2-ethylhexyloxy)aniline (prepared according to the method described for 1a) (7.5 g, 13.7 mmol) is dissolved in NMP (135 ml) and to this is added 40% (w/w) nitrosyl sulfuric acid in sulfuric acid (6.2 g, 19.5 mmol) allowing the mixture to exotherm. After 30 minutes, the diazonium salt solution is added slowly to a solution of N,N-di-(3,5,5-trimethylhexyl)-m-toluidine (14.3 mmol) and 10% sulfamic acid (20 ml) in acetone (200 ml) and ice (200 g). After stirring overnight, the solid is filtered off, washed with water, re-slurried in methanol (300 ml), filtered off and pulled dry. The filtered solid is dissolved in hexane and purified over silica gel, eluting with 50/50 dichloromethane/hexane. The enriched fractions are combined, concentrated in vacuo and the resultant black solid recrystallised from dichloromethane/methanol, to give the title compound, after drying, as a black powder (9.4 g, 79%); m.p. 103-105° C.; λₘₐₓ (hexane) 598 nm (43,500), FWHM 151 nm; ¹H nmr (300 MHz, CDCl₃) δ 0.87-1.75 (62H, br. m), 1.85 (2H, m), 2.73 (3H, s), 3.37 (4H, m), 4.03 (2H, m), 4.13 (2H, d, J 6.5), 6.52 (2H, m), 7.37 (1H, s), 7.41 (1H, s), 7.83 (1H, d, J 9.0), 7.89 (1H, d, J 9.0), 8.48 (1H, dd, J 2.0, J 9.0), 8.80 (1H, d, J 2.0).

### Example 1d

### Dye1d: 4-((E)-(4-((E)-(2,4-Dinitrophenyl)diazenyl)-2,5-bis(2-ethylhexyloxy)phenyl)diazenyl)-3-methyl-N,N-di-n-decylaniline

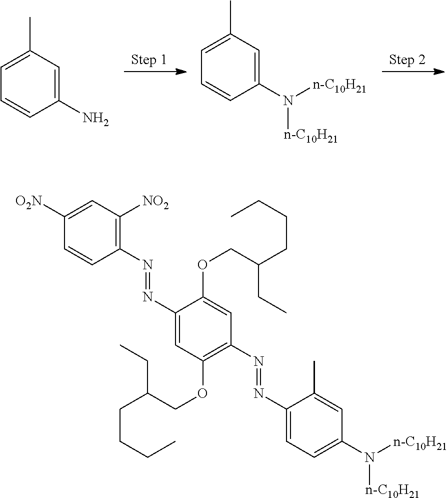

### Step 1: N,N-di-n-decyl-m-toluidine

A mixture of m-toluidine (10.7 g, 0.10 mol), 1-bromodecane (55.3 g, 0.25 mol), 1-methyl-2-pyrrolidone (50 ml) and sodium bicarbonate (21.0 g, 0.25 mol) is heated at 100° C. for 48 h. The reaction is allowed to cool, then partitioned between water (250 ml) and hexane (250 ml). The aqueous layer is extracted with further hexane (150 ml) and the combined organic layers were dried (MgSO₄) and evaporated to give a brown oil. Acetic anhydride (3 ml) is added, the mixture allowed to stand for 16 h, and then used directly without further purification, assuming 0.09 mol product.

### Step 2: 4-((E)-(4-((E)-(2,4-Dinitrophenyl)diazenyl)-2,5-bis(2-ethylhexyloxy)phenyl)diazenyl)-3-methyl-N,N-di-n-decylaniline

4-((2,4-Dinitrophenyl)diazenyl)-2,5-bis(2-ethylhexyloxy)aniline (prepared according to the method described for 1a) (7.5 g, 13.7 mmol) is dissolved in NMP (135 ml) and to this is added 40% (w/w) nitrosyl sulfuric acid in sulfuric acid (6.2 g, 19.5 mmol) allowing the mixture to exotherm. After 30 minutes, the diazonium salt solution is added slowly to a solution of N,N-di-n-decyl-m-toluidine (14.3 mmol) and 10% sulfamic acid (20 ml) in acetone (200 ml) and ice (200 g). After stirring overnight, the solid is filtered off, washed with water, re-slurried in methanol (200 ml), filtered off and pulled dry. The filtered solid is dissolved in hexane and purified over silica gel, eluting with 50/50 dichloromethane/hexane. The enriched fractions are combined, concentrated in vacuo and the resultant black solid recrystallised from dichloromethane/methanol, to give the title compound, after drying, as a black powder (9.5 g, 77%); m.p. 84-86° C.; λₘₐₓ (hexane) 598 nm (44,000), FWHM 150 nm; ¹H nmr (300 MHz, CDC₃) δ 0.90 (12H, m), 0.98 (6H, m), 1.20-1.70 (48H, m), 1.87 (2H, m), 2.72 (3H, s), 3.38 (4H, m), 4.02 (2H, d, J 6.5), 4.13 (2H, d, J 6.5), 6.52 (2H, m), 7.37 (1H, s), 7.40 (1H, s), 7.81 (1H, d, J 9.0), 7.87 (1H, d, J 9.0), 8.48 (1H, dd, J 2.0, J 9.0), 8.78 (1H, d, J 2.0).

### Example 1e

### Dye1e: 4-((E)-(4-((E)-(2,4-Dinitrophenyl)diazenyl)-2,5-bis(2-ethylhexyloxy)phenyl)diazenyl)-3-methyl-N,N-di-n-dodecylaniline

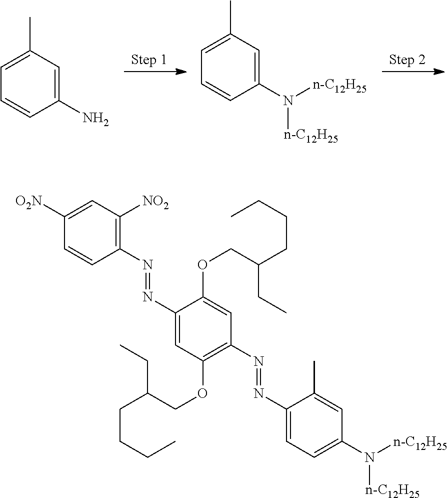

### Step 1: N,N-di-n-dodecyl-m-toluidine

A mixture of m-toluidine (10.7 g, 0.10 mol), 1-bromododecane (62.3 g, 0.25 mol), 1-methyl-2-pyrrolidone (50 ml) and sodium bicarbonate (21.0 g, 0.25 mol) are heated at 100° C. for 72 h. The reaction is alloyed to cool, then poured into water (250 ml) and extracted with hexane (2×250 ml). The organic layer is dried (MgSO₄) and evaporated to give a brown oil. Acetic anhydride (3 ml) is added and allowed to stand for 16 h, during which time the oil solidified. The resultant waxy solid is triturated with 2-propanol (200 ml), filtered off and dried in a desiccator. The required product is obtained as an off-white solid (29.2 g, 66%).

### Step 2: 4-((E)-(4-((E)-(2,4-Dinitrophenyl)diazenyl)-2,5-bis(2-ethylhexyloxy)phenyl)diazenyl)-3-methyl-N,N-di-n-dodecylaniline

4-((2,4-Dinitrophenyl)diazenyl)-2,5-bis(2-ethylhexyloxy)aniline (prepared according to the method described for 1a) (7.5 g, 13.7 mmol) is dissolved in NMP (135 ml) and to this is added 40% (w/w) nitrosyl sulfuric acid in sulfuric acid (6.2 g, 19.5 mmol) allowing the mixture to exotherm. After 30 minutes, the diazonium salt solution is added slowly to a solution of N,N-di-n-dodecyl-m-toluidine (7.1 g, 14.3 mmol) and 10% sulfamic acid (20 ml) in acetone (200 ml) and ice (200 g). After stirring overnight, the solid is filtered off, washed with water, re-slurried in methanol (200 ml), filtered off and pulled dry. The filtered solid is dissolved in hexane and purified over silica gel, eluting with 50/50 dichloromethane/hexane. The enriched fractions are combined, concentrated in vacuo and the resultant black gum crystallised from dichloromethane/methanol, to give the title compound as a black powder (7.3 g, 56%); m.p. 84-87° C.; λₘₐₓ (hexane) 598 nm (45,000), FWHM 150 nm; ¹H nmr (300 MHz, CDC₃) δ 0.88 (12H, m), 0.96 (6H, m), 1.20-1.70 (56H, m), 1.87 (2H, m), 2.75 (3H, s), 3.36 (4H, m), 4.02 (2H, d, J 6.5), 4.12 (2H, d, J 6.5), 6.52 (2H, m), 7.37 (1H, s), 7.40 (1H, s), 7.81 (1H, d, J 9.0), 7.89 (1H, d, J 9.0), 8.48 (1H, dd, J 2.0, J 9.0), 8.78 (1H, d, J 2.0).

### Example 1f

### Dye1f: 4-((E)-(4-((E)-(2,4-Dinitrophenyl)diazenyl)-2,5-bis(2-ethylhexyloxy)phenyl)diazenyl)-3-methyl-N,N-di-n-tetradecylaniline

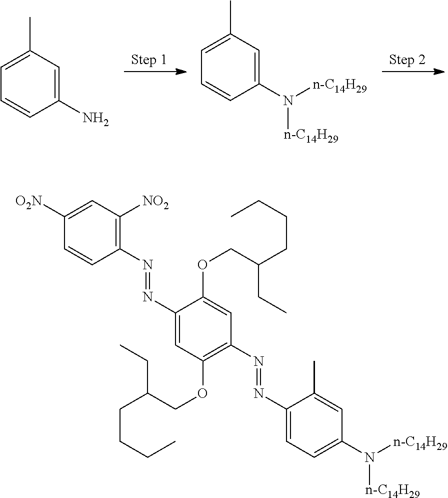

### Step 1: N,N-di-n-tetradecyl-m-toluidine

A mixture of m-toluidine (10.7 g, 0.10 mol), 1-bromotetradecane (69.3 g, 0.25 mol), 1-methyl-2-pyrrolidone (50 ml) and sodium bicarbonate (21.0 g, 0.25 mol) is heated at 100° C. for 48 h. The reaction is allowed to cool, then poured into water (500 ml) and hexane (300 ml) added. The organic layer is separated, dried (MgSO₄), acetic anhydride (5 ml) is added and the solution evaporated to give a brown oil. Methanol (500 ml) is added to the oil and shaken vigorously, allowed to settle and then decanted off. The oil is then triturated with acetonitrile (500 ml), which caused it to solidify. The solid is filtered off and dried at 40° C. overnight to give the title compound as an off-white wax (46.5 g, 93%).

### Step 2: 4-((E)-(4-((E)-(2,4-dinitrophenyl)diazenyl)-2,5-bis(2-ethylhexyloxy)phenyl)diazenyl)-3-methyl-N,N-di-n-tetradecylaniline

4-((2,4-Dinitrophenyl)diazenyl)-2,5-bis(2-ethylhexyloxy)aniline (prepared according to the method described for 1a) (7.5 g, 13.7 mmol) was dissolved in NMP (135 ml) and to this was added 40% (w/w) nitrosyl sulfuric acid in sulfuric acid (6.2 g, 19.5 mmol) allowing the mixture to exotherm. After 45 minutes, the diazonium salt solution is added slowly to a solution of N,N-di-n-tetradecyl-m-toluidine (7.1 g, 14.3 mmol) and 10% sulfamic acid (30 ml) in a mixture of acetone (300 ml), NMP (200 ml), dichloromethane (200 ml) and ice (200 g). After stirring overnight, the supernatant is decanted off to leave a black solid, which is re-slurried in water (200 ml) and filtered off. The solid is slurried in methanol, filtered off and pulled dry, then dissolved in dichloromethane (200 ml) and dried over Na₂SO₄. After evaporation of solvent, the resultant solid is purified over silica gel, eluting with an increasing gradient of dichloromethane (0% to 30%) in hexane. The enriched fractions are combined and concentrated in vacuo and the solid recrystallised from dichloromethane/methanol, to give the title compound as a black powder (9.7 g, 67%); m.p. 73-75° C.; λₘₐₓ (hexane) 599 nm (44,750), FWHM 149 nm; ¹H nmr (300 MHz, CDCl₃) δ 0.88 (12H, m), 0.96 (6H, m), 1.20-1.70 (64H, m), 1.87 (2H, m), 2.75 (3H, s), 3.36 (4H, m), 4.02 (2H, d, J 6.5), 4.12 (2H, d, J 6.5), 6.52 (2H, m), 7.37 (1H, s), 7.40 (1H, s), 7.81 (1H, d, J 9.0), 7.89 (1H, d, J 9.0), 8.48 (1H, dd, J 2.0, J 9.0), 8.77 (1H, d, J 2.0).

### Example 1g

### Dye1g: 4-((E)-(4-((E)-(2,4-Dinitrophenyl)diazenyl)-2,5-bis(2-ethylhexyloxy)phenyl)diazenyl)-3-methyl-N-dodecyl-N-(3,5,5-trimethylhexyl)aniline

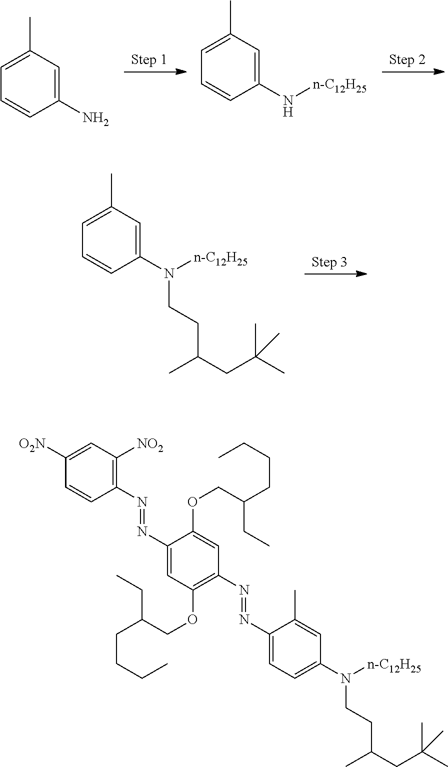

### Step 1: N-dodecyl-m-toluidine

A mixture of m-toluidine (107.2 g, 1.0 mol) and 1-bromododecane (24.9 g, 0.1 mol) is heated at 100° C. for 4 h then the bulk of the excess m-toluidine is distilled out under reduced pressure. The remaining oil solidifies on cooling. This solid is triturated with water, collected by filtration, then partitioned between hexane and 2N NaOH. The organic layer is separated, dried (Na₂SO₄) then applied to a pad of silica gel. After washing with hexane, the pure title compound is eluted with 80/20 hexane/CHCl₃, and obtained as a free-flowing pale yellow oil (21.8 g, 79%) after evaporation of solvent in vacuo.

### Step 2: N-dodecyl-N-(3,5,5-trimethylhexyl)-m-toluidine

A mixture of N-dodecyl-m-toluidine (8.0 g, 0.029 mol), 1-bromo-3,5,5-trimethylhexane (7.6 g, 0.035 mol), 1-methyl-2-pyrrolidone (15 ml) and sodium bicarbonate (2.9 g, 0.034 mol) is heated at 100° C. br 72 h. The reaction is allowed to cool then partitioned between water (250 ml) and hexane (250 ml). The aqueous layer is extracted with further hexane (150 ml) and the combined organic layers are dried (MgSO₄) and evaporated to give a brown oil. The material is purified over silica gel, eluting with hexane/dichloromethane (10:1) to afford the title compound as a colourless oil (6.8 g, 58%).

### Step 3: 4-((E)-(4-((E)-(2,4-Dinitrophenyl)diazenyl)-2,5-bis(2-ethylhexyloxy)phenyl)diazenyl)-3-methyl-N-dodecyl-N-(3,5,5-trimethylhexyl)aniline

4-((2,4-Dinitrophenyl)diazenyl)-2,5-bis(2-ethylhexyloxy)aniline (prepared according to the method described for 1a) (7.5 g, 13.7 mmol) is dissolved in NMP (130 ml) and to this is added 40% (w/w) nitrosyl sulfuric acid in sulfuric acid (6.2 g, 19.5 mmol) allowing the mixture to exotherm. After 30 minutes, the diazonium salt solution is added slowly to a solution of N-dodecyl-N-(3,5,5-trimethylhexyl)-m-toluidine (5.7 g, 14.3 mmol) and 10% sulfamic acid (20 ml) in acetone (200 ml) and ice (200 g). After stirring overnight, the solid is filtered off, washed with water, re-slurried in methanol (300 ml), filtered off and dried overnight at 40° C. The filtered solid is dissolved in hexane and purified over silica gel, eluting with 50/50 dichloromethane/hexane. The enriched fractions are combined, concentrated in vacuo and the resultant black solid recrystallised from dichloromethane/methanol, to give the title compound, after drying, as a black powder (7.1 g, 57%); m.p. 69-71° C.; λₘₐₓ (hexane) 600 nm (45,000), FWHM 151 nm; ¹H nmr (300 MHz, CDC₃) δ 0.85-1.20 (28H, m), 1.20-1.75 (40H, m), 1.85 (2H, m), 2.72 (3H, s), 3.37 (4H, m), 4.03 (2H, d, J 6.5), 4.12 (2H, d, J 6.5), 6.51 (2H, m), 7.35 (1H, s), 7.40 (1H, s), 7.83 (1H, d, J 9.0), 7.88 (1H, d, J 9.0), 8.48 (1H, dd, J 2.0, J 9.0), 8.78 (1H, d, J 2.0).

### Example 1 h

### Dye1h: 4-((E)-(4-((E)-(2,4-Dinitrophenyl)diazenyl)-2,5-bis(2-ethylhexyloxy)phenyl)diazenyl)-3-methyl-N-dodecyl-N-(2-ethylhexyl)aniline

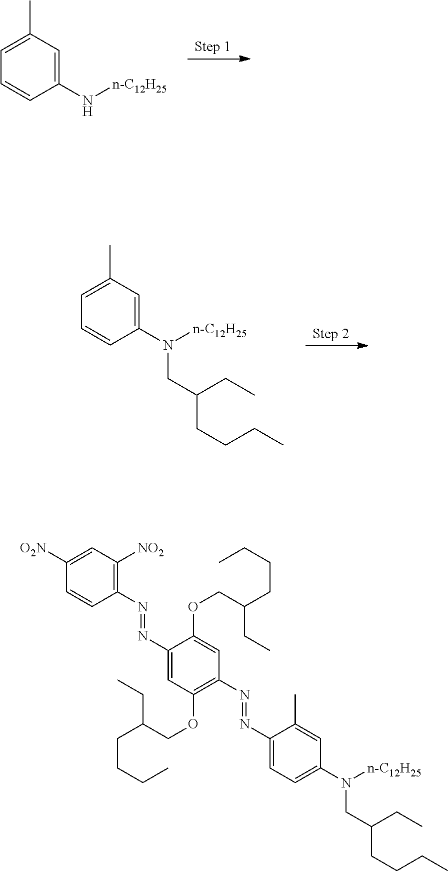

### Step 1: N-dodecyl-N-(2-ethylhexyl)-m-toluidine

A mixture of N-dodecyl-m-toluidine (prepared according to the procedure described above for Merck HSK 1a) (8.0 g, 0.029 mol), 1-bromo-2-ethylhexane (6.7 g, 0.035 mol), 1-methyl-2-pyrrolidone (15 ml) and sodium bicarbonate (2.9 g, 0.034 mol) is heated at 100° C. for 96 h. The reaction is allowed to cool then partitioned between water (250 ml) and hexane (250 ml). The aqueous layer is extracted with further hexane (150 ml) and the combined organic layers were dried (MgSO₄) and evaporated to give a brown oil. The material is purified over silica gel, eluting with hexane/dichloromethane (10:1) to afford the title compound as a colourless oil (7.7 g, 68%).

### Step 2: 4-((E)-(4-((E)-(2,4-Dinitrophenyl)diazenyl)-2,5-bis(2-ethylhexyloxy)phenyl)diazenyl)-3-methyl-N-dodecyl-N-(2-ethylhexyl)aniline

4-((2,4-Dinitrophenyl)diazenyl)-2,5-bis(2-ethylhexyloxy)aniline (prepared according to the method described for 1a) (7.5 g, 13.7 mmol) is dissolved in NMP (130 ml) and to this was added 40% (w/w) nitrosyl sulfuric acid in sulfuric acid (6.2 g, 19.5 mmol) allowing the mixture to exotherm. After 30 minutes, the diazonium salt solution is added slowly to a solution of N-dodecyl-N-(3,5,5-trimethylhexyl)-m-toluidine (5.7 g, 14.3 mmol) and 10% sulfamic acid (20 ml) in acetone (200 ml) and ice (200 g). After stirring overnight, the resultant black oil is extracted with hexane (500 ml), washed with 0.2N NaOH (3×100 ml), dried (MgSO₄) and evaporated in vacuo. The obtained black oil is diluted with hexane and purified over silica gel, eluting with an increasing gradient of dichloromethane (0-50%) in hexane. The enriched fractions are combined and concentrated in vacuo to give the title compound as a black semi-solid (5.4 g, 44%); λₘₐₓ (hexane) 599 nm (42,750), FWHM 150 nm; ¹H nmr (300 MHz, CDCl₃) δ 0.80-1.02 (21H, m), 1.20-1.70 (45H, m), 1.85 (3H, m), 2.72 (3H, s), 3.29 (2H, m), 3.40 (2H, m), 4.03 (2H, m), 4.12 (2H, d, J 6.5), 6.56 (2H, m), 7.36 (1H, s), 7.40 (1H, s), 7.82 (1H, d, J 9.0), 7.88 (1H, d, J 9.0), 8.48 (1H, dd, J 2.0, J 9.0), 8.78 (1H, d, J 2.0).

### Example 2

### Dye 2: 4-((E)-(4-((E)-(2,4-Dinitrophenyl)diazenyl)-2,5-bis(2-ethylhexyloxy)phenyl)diazenyl)-3-methyl-N,N-octyl/ethylhexyl-aniline

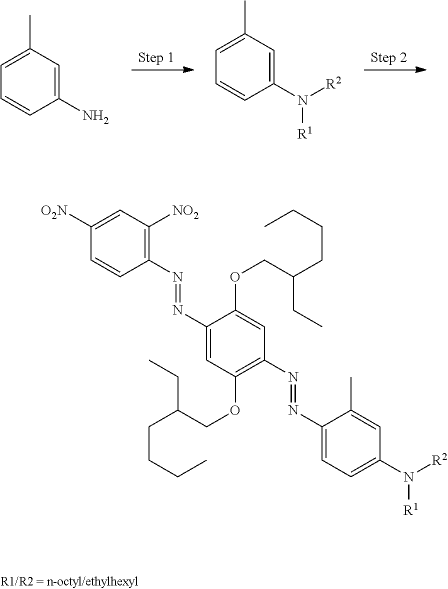

### Step 1: N,N-(2-ethylhexyl)/n-octyl-m-toluidine

A mixture of m-toluidine (10.7 g, 0.10 mol), 1-bromo-2-ethylhexane (29.0 g, 0.15 mol), 1-bromooctane (19.3 g, 0.1 mol), 1-methyl-2-pyrrolidinone (50 ml) and sodium bicarbonate (21.0 g, 0.25 mol) is heated at 100° C. overnight. The reaction is allowed to cool, then poured into water (500 ml) and ether (250 ml) added. The organic layer is separated, dried (Na₂SO₄) and evaporated. Acetic anhydride (5 ml) is added to the isolated oil. HPLC showed a 5:11:47:35 a/a % mixture of mono-alkylated:bis-isooctyl:mixed di-alkylated:bis-n-octyl materials. The mixture is used directly without further purification.

### Step 2: 4-((E)-(4-((E)-(2,4-Dinitrophenyl)diazenyl)-2,5-bis(2-ethylhexyloxy)phenyl)diazenyl)-3-methyl-N,N-(2-ethylhexyl)/n-octyl-aniline

4-((2,4-Dinitrophenyl)diazenyl)-2,5-bis(2-ethylhexyloxy)aniline (prepared according to the method described for Dye 1) (2.8 g, 4.9 mmol) is dissolved in NMP (50 ml) and to this is added 40% (w/w) nitrosyl sulfuric acid in sulfuric acid (2.3 g, 7.3 mmol) allowing the mixture to exotherm. After 30 minutes, the diazonium salt solution is added to a solution of N,N-(2-ethylhexyl)/n-octyl-m-toluidine (1.62 g, 4.9 mmol) and 10% sulfamic acid (10 ml) in acetone (200 ml) and ice/water (100 g). After stirring overnight, the aqueous supernatant is decanted off to leave a viscous black oil, which is dissolved in dichloromethane, washed with 0.1N NaOH, dried over sodium sulfate and evaporated to give a black oil. The oil is dissolved in a minimum volume of hexane, applied to silica gel and eluted with an increasing gradient of dichloromethane (20-40%) in hexane. The fractions containing pure blue dye were combined and evaporated to a black oil (2.3 g, 55%), which solidified on standing. λₘₐₓ (hexane) 599 nm (39,500), FWHM 151 nm.

### Example 3

### Dye 3: 4-((E)-(4-((E)-(2,4-Dinitrophenyl)diazenyl)-2,5-bis(2-ethylhexyloxy)phenyl)diazenyl)-3-methyl-N,N-n-dodecyl/(3,5,5-trimethylhexyl)-aniline

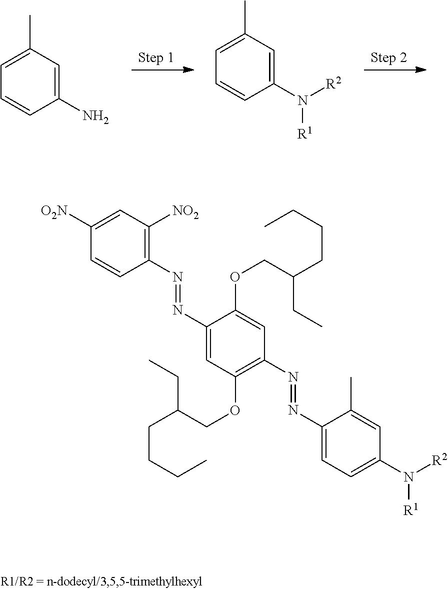

### Step 1: N,N-n-dodecyl/(3,5,5-trimethylhexyl)-m-toluidine

Prepared according to the procedure outlined for Dye 2, Step 1 using 1-bromo-3,5,5-trimethylhexane (27.3 g, 0.125 mol) and 1-bromododecane (31.2 g, 0.125 mol), and used directly without further purification.

### Step 2: 4-((E)-(4-((E)-(2,4-Dinitrophenyl)diazenyl)-2,5-bis(2-ethylhexyloxy)phenyl)diazenyl)-3-methyl-N,N-n-dodecyl/(3,5,5-trimethylhexyl)-aniline

Prepared according to the procedure outlined for Dye 2, Step 2. From 4-((2,4-Dinitrophenyl)diazenyl)-2,5-bis(2-ethylhexyloxy)aniline (4.0 g, 7 mmol), the required product mixture is obtained as a black oil (4.5 g, 67%). λₘₐₓ (hexane) 599 nm (38,500), FWHM 153 nm.

### Example 4

### Dye 4: 4-((E)-(4-((E)-(2,4-Dinitrophenyl)diazenyl)-2,5-bis(2-ethylhexyloxy)phenyl)diazenyl)-3-methyl-N,N-n-dodecyl/(2-ethylhexyl)-aniline

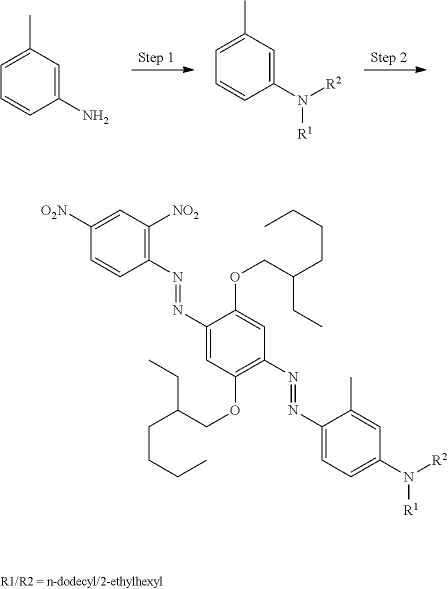

### Step 1: N,N-n-dodecyl/(2-ethylhexyl)-m-toluidine

Prepared according to the procedure outlined for Dye 2, Step 1 using 1-bromo-2-ethylhexane (29.0 g, 0.15 mol) and 1-bromododecane (24.9 g, 0.1 mol), and used directly without further purification.

### Step 2: 4-((E)-(4-((E)-(2,4-Dinitrophenyl)diazenyl)-2,5-bis(2-ethylhexyloxy)phenyl)diazenyl)-3-methyl-N,N-n-dodecyl/(2-ethylhexyl)-aniline

Prepared according to the procedure outlined for Dye 2, Step 2. From 4-((2,4-Dinitrophenyl)diazenyl)-2,5-bis(2-ethylhexyloxy)aniline (3.46 g, 6.7 mmol), the required product mixture is obtained as a black oil (4.2 g, 66%). λₘₐₓ (hexane) 599 nm (34,000), FWHM 158 nm.

### Example 5

### Dye 5: 4-((E)-(4-((E)-(2,4-Dinitrophenyl)diazenyl)-2,5-bis(2-ethylhexyloxy)phenyl)diazenyl)-3-methyl-N,N-(2-ethylhexyl)/(3,5,5-trimethylhexyl)/n-decyl/n-dodecyl-aniline

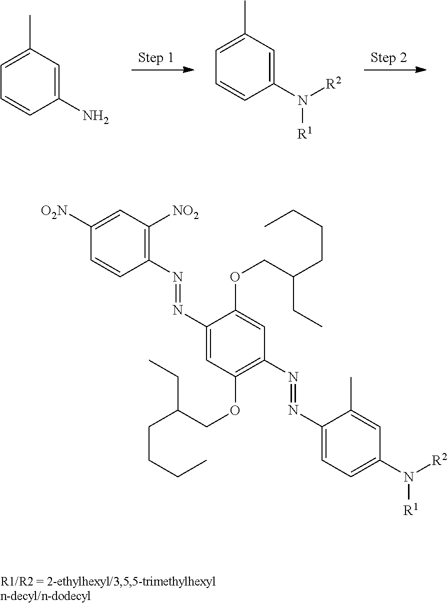

### Step 1: N,N-(2-ethylhexyl)/(3,5,5-trimethylhexyl)/n-decyl/n-dodecyl-m-toluidine

Prepared according to the procedure outlined for Dye 2, Step 1 using 1-bromo-2-ethylhexane (19.3 g, 0.1 mol), 1-bromo-3,5,5-trimethylhexane (10.9 g, 0.05 mol), 1-bromodecane (11.1 g, 0.05 mol) and 1-bromododecane (12.5 g, 0.05 mol), and used directly without further purification.

### Step 2: 4-((E)-(4-((E)-(2,4-Dinitrophenyl)diazenyl)-2,5-bis(2-ethylhexyloxy)phenyl)diazenyl)-3-methyl-N,N-(2-ethylhexyl)/(3,5,5-trimethylhexyl)/n-decyl/n-dodecyl-aniline

Prepared according to the procedure outlined for Dye 2, Step 2. 4-((2,4-Dinitrophenyl)diazenyl)-2,5-bis(2-ethylhexyloxy)aniline (4.0 g, 7 mmol), the required product mixture is obtained as a black oil (4.0 g, 61%). λₘₐₓ (hexane) 598 nm (40,500), FWHM 154 nm.

### Example 6

### Dye 6: 4-((E)-(4-((E)-(2,4-Dinitrophenyl)diazenyl)-2,5-bis(2-ethylhexyloxy)phenyl)diazenyl)-3-methyl-N,N-n-tetradecyl/(2-ethylhexyl)-aniline

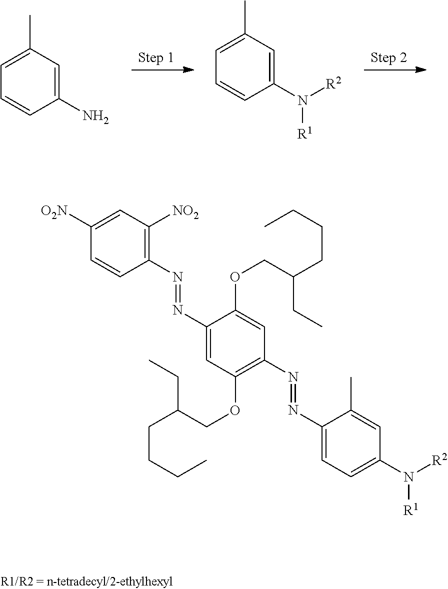

### Step 1: N,N-n-tetradecyl/(2-ethylhexyl)-m-toluidine

Prepared according to the procedure outlined for Dye 2, Step 1 using 1-bromo-2-ethylhexane (29.0 g, 0.15 mol) and 1-bromotetradecane (27.7 g, 0.1 mol), and used directly without further purification.

### Step 2: 4-((E)-(4-((E)-(2,4-Dinitrophenyl)diazenyl)-2,5-bis(2-ethylhexyloxy)phenyl)diazenyl)-3-methyl-N,N-n-tetradecyl/(2-ethylhexyl)-aniline

Prepared according to the procedure outlined for Dye 2, Step 2. From 4-((2,4-Dinitrophenyl)diazenyl)-2,5-bis(2-ethylhexyloxy)aniline (3.46 g, 6.7 mmol), of the required product mixture was obtained as a black oil (4.2 g, 68%). λₘₐₓ (hexane) 598 nm (34,000), FWHM 167 nm.

### Example 7

### Dye 7: 4-((E)-(4-((E)-(2,4-Dinitrophenyl)diazenyl)-2,5-bis(2-ethylhexyloxy)phenyl)diazenyl)-3-methyl-N,N-n-decyl/(2-ethylhexyl)-aniline

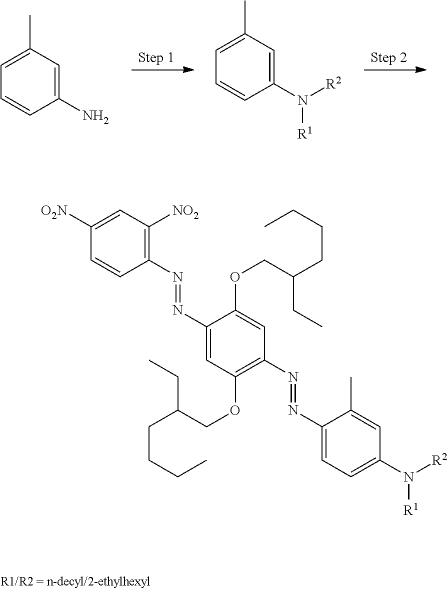

### Step 1: N,N-(2-ethylhexyl)/n-decyl-m-toluidine

Prepared according to the procedure outlined for Dye 2, Step 1 using 1-bromo-2-ethylhexane (29.0 g, 0.15 mol) and 1-bromodecane (22.1 g, 0.1 mol), and used directly without further purification.

### Step 2: 4-((E)-(4-((E)-(2,4-Dinitrophenyl)diazenyl)-2,5-bis(2-ethylhexyloxy)phenyl)diazenyl)-3-methyl-N,N-n-decyl/(2-ethylhexyl)-aniline

Prepared according to the procedure outlined for Dye 2, Step 2. From 4-((2,4-Dinitrophenyl)diazenyl)-2,5-bis(2-ethylhexyloxy)aniline (3.46 g, 6.7 mmol), of the required product mixture was obtained as a black gum (4.2 g, 68%). λₘₐₓ (hexane) 599 nm (45,000), FWHM 153 nm.

### Example 8

### Dye 15: (E)-3-Methyl-4-((4-nitrophenyl)diazenyl)-N,N-dioctylaniline

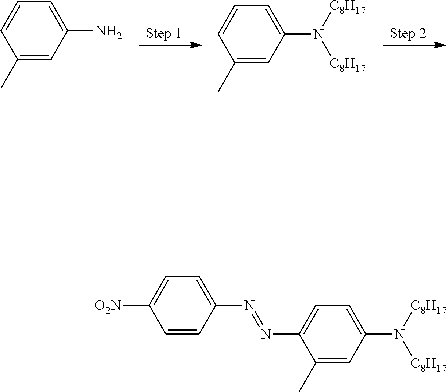

### Step 1: Step 1a: 3-Methyl-N,N-dioctylaniline

m-Toluidine (26.75 g, 0.25 mol), water (30 ml), 1-bromooctane (144.9 g, 0.75 mol), and MgO (100.8 g, 2.5 mol) are charged and the resultant suspension heated to 110° C. (bath temp) for 48 h. The reaction mixture is allowed to cool and hexane (100 ml) is added, causing precipitation of further solid. The solids are filtered-off to give an off-white filter cake and a yellow/brown filtrate. The filter cake is suspended in methylene chloride (100 ml), washed with dilute NaOH (3×100 ml), and dried over MgSO₄. The solution is filtered then passed through a small pad of silica gel to give a pale yellow filtrate. Evaporation of solvent gives the product as a pale yellow free flowing oil (34.5 g, 42%). ¹H NMR shows expected signals. Step 2: (E)-3-methyl-4-((4-nitrophenyl)diazenyl)-N,N-dioctylaniline 4-Nitroaniline (4.14 g, 0.03 mol) is suspended in dilute HCl and to this is added a solution of sodium nitrite (2.2 g, 0.032 mol) at 0-5° C., pH<1. Excess nitrous acid is destroyed by adding sulfamic acid and the solution is added dropwise to a solution of 3-Methyl-N,N-dioctylaniline (10.6 g, 0.032 mol) in aqueous acetone. The resultant red tarry solid suspension is stirred overnight at ambient temperature and the solid filtered-off, washed with water then recrystallised from IMS. The resultant dark red crystalline solid is collected by filtration, washed with IMS and dried at 40° C. (11.5 g, 80%); mp=44-46° C.; λₘₐₓ (hexane) 470 nm (36,000), FWHM 93 nm.

### Example 9

### Dye 8: N-(2-((2,6-Dicyano-4-nitrophenyl)diazenyl)-5-(dioctadecylamino)-4-methoxyphenyl)acetamide

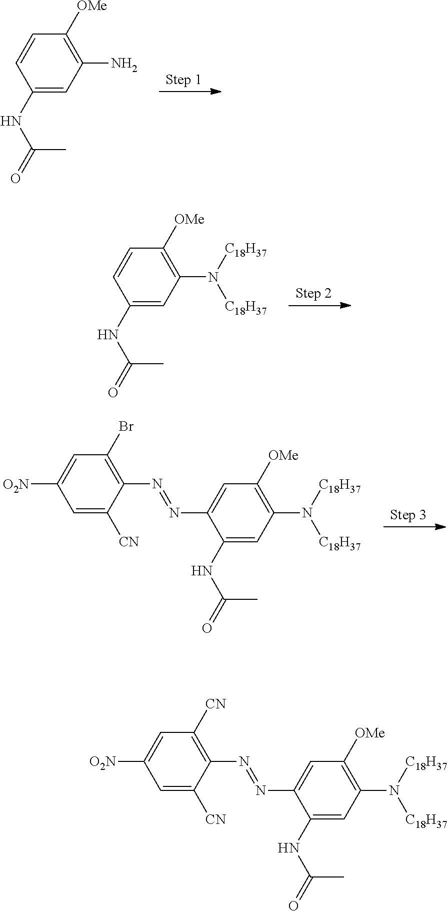

### Step 1: N-(3-(Dioctadecylamino)-4-methoxyphenyl)acetamide

N-(3-Amino-4-methoxyphenyl)acetamide (42 g, 0.23 mol), 1-bromooctadecane (194 g, 0.583 mol), sodium bicarbonate (49 g, 0.583 mol) and N-methyl-2-pyrrolidone (140 ml) are charged and heated at 80° C. for 16 hours. Acetic anhydride (15 ml) is added and stirring continued at 105° C. for 1 hour, before methanol (10 ml) is added. After stirring overnight, the reaction is allowed to cool to 25° C. before water (1 L) is added. The resultant solid is filtered off and then dissolved in methylene chloride (1 L). The organic solution is washed with water (500 ml), dried over MgSO₄ and treated with ca 20 g of activated charcoal for 15 minutes. The solution is filtered through a silica pad, washing with methylene chloride (2×500 ml). The combined organic layers are evaporated to a thick brown oil. This oil is suspended in acetonitrile (1 L) whist still hot (40-45° C.) and stirred rapidly overnight to give a fine suspension. The solid is filtered and washed with acetonitrile (500 ml), then dried at 40° C. to give N-(3-(dioctadecylamino)-4-methoxyphenyl)acetamide as a pale brown solid (153.0 g). ¹H NMR analysis showed the presence of ca 20 mol % residual 1-bromooctadecane in the solid; therefore, organic content estimated at 80%. Strength adjusted yield 122.4 g, 78%; (CDC₃, 300 MHz): δ 0.9 (6H, t), 1.2-1.6 (64H, m), 2.2 (3H, s), 3.1 (4H, br. t), 3.8 (3H, s), 6.8 (1H, d), 7.1 (2H, br. m); MS (ES+): [M+H]⁺=685.6 (70%).

### Step 2: N-(2-((2-Bromo-6-cyano-4-nitrophenyl)diazenyl)-5-(dioctadecylamino)-4-methoxyphenyl)-acetamide

80% (w/w) Sulfuric acid (100 ml) is chilled to 5° C. in an ice bath and 6-bromo-2-cyano-4-nitroaniline (12.8 g, 52.6 mmol) is added. 40% Nitrosyl sulfuric acid in sulfuric acid (19.0 g, 60 mmol) is added over ca 60 minutes at 5-8° C. and the solid is dissolved to give a greenish-black diazonium salt solution. N-(3-(Dioctadecylamino)-4-methoxyphenyl)acetamide (45.0 g, 52.6 mmol) is dissolved in CH₂Cl₂ (500 ml). Water (300 ml) and sulfamic acid (ca 5 g) are added to give a biphasic mixture. Ice (500 g) is added in portions whilst the above diazonium salt solution is added slowly over about 10 minutes. Solid Na₂CO₃ is added in portions until the aqueous layer is pH 4. The biphasic mixture is then allowed to stir overnight, allowing the CH₂Cl₂ to evaporate. The resultant sticky solid is filtered-off and washed with water (1 L), then slurried in IMS (500 ml) to give a powder which is filtered-off and washed on the filter with further IMS (1 L). The solid is recrystallised from boiling methyl isobutylketone (300 ml), then flashed through silica gel eluting with methylene chloride. The purest fractions are combined and evaporated to give the required compounds as a black solid (6.4 g, 13%).

### Step 3: N-(2-((2,6-Dicyano-4-nitrophenyl)diazenyl)-5-(dioctadecylamino)-4-methoxyphenyl)acetamide

N-(2-((2-Bromo-6-cyano-4-nitrophenyl)diazenyl)-5-(dioctadecylamino)-4-methoxyphenyl)acetamide (5.5 g, 5.9 mmol), copper(I) cyanide (0.58 g, 6.5 mmol), N-methyl-2-pyrrolidone (55 ml) and toluene (5 ml) are charged and heated at 100° C. for 1 h. Methanol (150 ml) is added to the hot solution slowly, allowed to stir a further 1 h and the solid is filtered-off and washed on the filter with further methanol. A second identical reaction is carried out with 6.1 mmol substrate. The crude isolated solids are combined and purified over silica gel eluting with CH₂Cl₂ to give the required compound as a black solid (6.2 g, 58%); mp: 95-97° C.; λₘₐₓ (hexane) 642 nm (103,000), FWHM 44 nm; ¹H NMR showed expected signals.

### Example 10

### Dye 9: 1,4-Bis(2-ethylhexyl/n-octyl/n-undecyl/n-dodecyl-amino)anthracene-9,10-dione

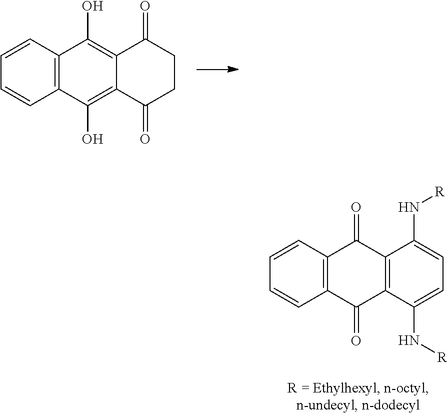

Water (550 ml) is degassed under vacuum for 30 minutes, then released to nitrogen. Under a nitrogen stream, potassium carbonate (2.75 g, 20 mmol) and sodium hydrosulfite (16.6 g, 95 mmol) are added and stirred until dissolved. 9,10-Dihydroxy-2,3-dihydroanthracene-1,4-dione (5.53 g, 22.8 mmol) is added and the reaction is heated to 80° C. Octylamine (7.4 g, 57 mmol), 2-ethylhexylamine (7.4 g, 57 mmol), undecylamine (8.0 g, 47 mmol) and dodecylamine (10.6 g, 57 mmol) are mixed and heated to form a clear solution, and this mixture is then added to the leucoquinizarin in a single portion. The reaction is stirred at 80° C. overnight then allowed to cool to room temp. The resultant oil is extracted into dichloromethane, dried (Na₂SO₄) and evaporated to a green-blue oil. The oil is dissolved in methanol (150 ml) and then aerated with compressed air via a sintered gas tube for 2 h. A large amount of solid separated, which is filtered off. The solid is purified over a silica pad (50 g silica), applied in 25/75 DCM/hexane and eluted with an increasing gradient of dichloromethane (25-40%) in hexane. The blue containing fractions are combined and evaporated to give a blue solid (3.0 g). The mother liquors from the aeration reaction are evaporated to an oil, which is steam distilled for 1 h to remove the bulk of the fatty amines. The oil is separated from water, then boiled in hot dilute mineral acid (ca 0.1 M HCl). After cooling to ca 60° C., the oil is extracted into toluene, dried (MgSO₄) and evaporated to a thick blue oil. The solid is purified over a silica pad (50 g silica), applied in 25/75 DCM/hexane and eluted with an increasing gradient of dichloromethane (25-50%) in hexane. The blue containing fractions are combined and evaporated to give a blue solid (1.4 g). The two purified fractions are dissolved in dichloromethane, combined and evaporated to give a blue oil (3.4 g, 30%) which solidified on standing. λₘₐₓ (hexane) 645 nm (15,250).

### Example 11

### Dye 10: 1,4-Bis(2-ethylhexyl/n-dodecyl/n-tetradecyl/n-pentadecyl-amino)anthracene-9,10-dione

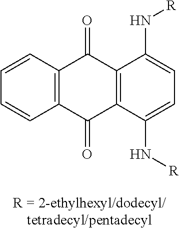

Prepared according to the procedure outlined for Dye 9, using a mixture of 2-ethylhexylamine (7.4 g, 57 mmol), dodecylamine (10.6 g, 57 mmol), tetradecylamine (12.1 g, 57 mmol) and pentadecylamine (13.0 g, 57 mmol). Compound mixture is obtained as a blue semi-solid. λₘₐₓ (hexane) 645 nm (15,250).

### Example 12

### Dye 11: N-(2-((4-Cyano-3-methylisothiazol-5-yl)diazenyl)-5-(dioctylamino)phenyl)acetamide

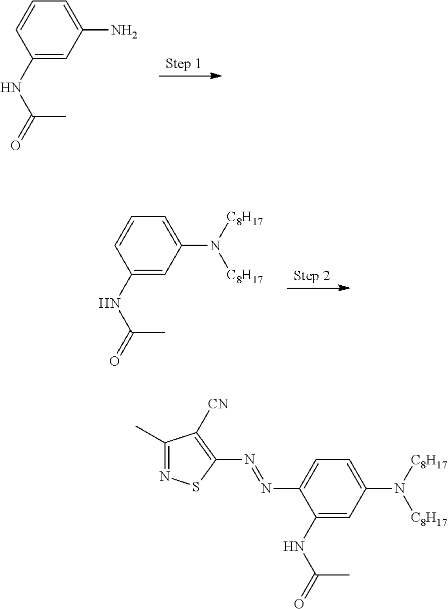

### Step 1: N-(3-(Dioctylamino)phenyl)acetamide

N-(3-Aminophenyl)acetamide (39.5 g, 0.26 mol), 1-bromooctane (127.2 g, 0.66 mol), N-methyl-2-pyrrolidone (125 ml) and sodium bicarbonate (55.2 g, 0.66 mol) are charged and heated at 100° C. overnight. Acetic anhydride (5 ml) is added at 100° C., stirred 1 h then methanol (20 ml) added and stirred a further 1 h. The entire reaction mass is allowed to cool then filtered. The solids are washed with methanol and all washings combined with the product solution. Solution of coupler is used directly with no further purification. HPLC showed 99% purity of the final material.

### Step 2: N-(2-((4-Cyano-3-methylisothiazol-5-yl)diazenyl)-5-(dioctylamino)phenyl)acetamide

5-Amino-3-methyl-4-isothiazolecarbonitrile (8.4 g, 0.06 mol) is suspended in a mixture of propionic acid (25 ml) and acetic acid (50 ml) and cooled externally in an ice/salt bath to 3° C. (internal temp.). 40% (w/w) Nitrosyl sulfuric acid in sulfuric acid (21.0 g, 0.066 mol) is then added dropwise over 1 h at 3-5° C. then stirred for a further 30 minutes at 3-5° C. minutes at which point all solid had dissolved to give a dark brown diazonium salt solution. N-(3-(Dioctylamino)phenyl)acetamide (0.06 mol) is diluted with methanol (200 ml) and 10% sulfamic acid solution (25 ml) added, followed by crushed ice (500 g). The diazonium salt solution is then added dropwise over ca 10 minutes to produce a precipitated purple solid. After a further 60 minutes of stirring, the solid is filtered-off and the filter cake is washed with water (1 L) until the filtrate ran colourless. The filter cake is dissolved in CH₂Cl₂ (1 L) and dried over MgSO₄. Methanol (600 ml) is then added and the dilute solution stirred overnight, allowing to evaporate slowly. The precipitated mass filtered-off, washed further with methanol (300 ml) then purified further over silica gel, eluting with CH₂Cl₂, then 2% acetone in CH₂Cl₂. The purest fractions were combined and evaporated, the solid is triturated in methanol (300 ml) and filtered-off, then dried to give the required product as a red solid (16.3 g, 52%) with >99% purity by HPLC; mp: 110-111° C.,λₘₐₓ (hexane) 536 nm (61,750), FWHM 71 nm; ¹H NMR showed two different conformers: (300 MHz, CDC₃) δ 0.9 (6H, m), 1.3 (20H, m), 1.7 (4H, m), 2.3 and 2.4 (3H, 2×s), 2.6 (3H, s), 3.5 (4H, q), 6.5 (1H, m), 7.5 and 7.9 (1H, 2×d), 8.1 and 8.3 (1H, 2×s), 9.0 and 12.5 (1H, 2×s).

### Example 13

### Dye 12: (E)-1-(2-Ethyl hexyl)-6-hydroxy-4-methyl-2-oxo-5-((4-tetradecylphenyl)diazenyl)-1,2-dihydropyridine-3-carbonitrile

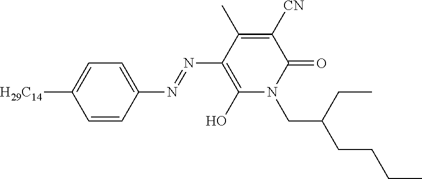

4-Tetradecylaniline (5.8 g, 20 mmol) is heated to melting in 2N HCl (25 ml) to give a white suspension. Water (50 ml) and ice (50 g) are added, followed by addition of 2N NaNO₂ (10.5 ml, 21 mmol) at 0-5° C. After 2 h at 0-5° C., be suspension is added to a solution of 1-(2-ethylhexyl)-6-hydroxy-4-methyl-2-oxo-1,2-dihydropyridine-3-carbonitrile (5.2 g, 20 mmol) in IMS (100 ml) and ice (100 g). After stirring overnight, the resultant solid is filtered-off and recrystallised twice from boiling 74 O.P. IMS to give the required compound as orange crystals (10.3 g, 92%); with >99% purity by HPLC; mp: 73-75° C., λₘₐₓ (hexane) 436 nm (45,000), FWHM 73 nm; ¹H NMR (300 MHz, CDC₃) δ 0.89 (9H, m), 1.20-1.35 (30H, m), 1.62 (2H, m), 1.82 (1H, m), 2.60-2.68 (5H, m), 3.89 (2H, m), 7.25 (2H, m), 7.41 (2H, m), 15.10 (1H, s).

### Example 14

### Dye 13: (E)-1-(2-ethylhexyl)-6-hydroxy-4-methyl-5-((4-tetradecylphenyl)diazenyl)pyridin-2(1H)-one

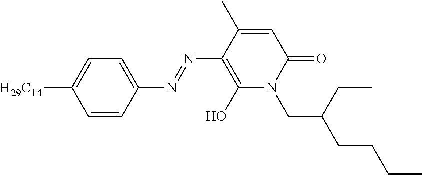

4-Tetradecylaniline (2.9 g, 10 mmol) is heated to melting in 2N HCl (15 ml) to give a white suspension. Water (30 ml) and ice (30 g) are added, followed by addition of 2N NaNO₂ (5.3 ml, 10.6 mmol) at 0-5° C. After 2 h at 0-5° C., the suspension is added to a solution of 1-(2-ethylhexyl)-6-hydroxy-4-methylpyridin-2(1H)-one (2.6 g, 11 mmol) in IMS (50 ml) and ice (50 g). After stirring overnight, the resultant solid is filtered-off and recrystallised twice from boiling 74 O.P. IMS to give the required compound as greenish-yellow crystals (4.5 g, 83%); mp: 63-65° C., λₘₐₓ (hexane) 416 nm (38,000), FWHM 67 nm; ¹H NMR (300 MHz, CDC₃) δ 0.89 (9H, m), 1.22-1.38 (30H, m), 1.61 (2H, m), 1.84 (1H, m), 2.29 (3H, d, J 0.5), 2.60-2.68 (2H, t, J 7.5), 3.86 (2H, m), 6.12 (1H, d, J 0.5), 7.20 (2H, d, J 7.0), 7.34 (2H, d, J 7.0), 14.55 (1H, s).

### Example 15

### Dye 14: ((E)-N,N-dibutyl-4-((4-butylphenyl)diazenyl)aniline

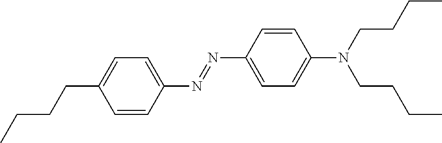 [SMILES: CCCCc1ccc(/N=N/c2ccc(N(CCCC)CCCC)cc2)cc1]

4-Butylaniline (3.0 g, 20 mmol) is dissolved in 0.1 N HCl (100 ml) and cooled to <5° C. by adding ice. 2N sodium nitrite solution is added dropwise at 5-10° C. until the solution no longer tested positive to Ehrlich's reagent and the excess nitrous acid was destroyed by adding sulfamic acid. N,N-Dibutylaniline (4.5 g, 22 mmol) is dissolved in a 50/50 mixture of pyridine/water (100 ml), ice (50 g) is added and the diazonium salt solution poured in. After stirring overnight, the resultant oil is extracted into hexane, dried (Na₂SO₄) and evaporated. The red oil was dissolved in a minimum volume of hexane, applied to silica gel and eluted with an increasing gradient of dichloromethane (30-50%) in hexane. The fractions containing pure yellow dye were combined and evaporated to an orange oil (6.0 g, 82%), λₘₐₓ (hexane) 407 nm (38,000), FWHM 68 nm; ¹H NMR (300 MHz, CDC₃) δ 0.92 (3H, t, J 8.5), 0.96 (6H, t, J 8.5), 1.38 (6H, m), 1.64 (6H, m), 2.66 (2H, m), 3.36 (4H, m), 6.68 (2H, dm, J 9.0), 7.26 (2H, dm, J 8.5), 7.74 (2H, dm, J 8.5), 7.82 (2H, dm, J 9.0).

### Example 16

### Solubility Testing

Solubility testing has been standardised such that direct comparisons between compounds can be made. A typical solubility test consists of one or more dyes dissolved in a suitable non-polar (hydrophobic) solvent, for example decane, at a concentration of 20% by weight for each dye. Samples are first vortex mixed for approximately 3 minutes and sonicated at 50° C. br 30 mins. They are then stirred for approximately 16 hours to ensure complete saturation. After stirring, samples are left to stand at room temperature for 2 hours before filtering through a 200 nm PTFE filter to give a saturated solution of dye in solvent.

The saturation concentrations and/or absorbance data for cells of varying thickness can be derived using the Beer-Lambert law:

A=ecl,

Where A is absorbance (arbitrary unit) e=Molar extinction coefficient, c=Concentration (mol/l), l=path length (cm).

The absorbance is measured using a Hitachi UV3310 UV-vis spectrophotometer.

Experimental data (in decane) is presented on commercially available and hydrocarbon soluble dyes of the invention. Data aims to show an improved solubility and widened absorbance spectrums in dyes of the invention by

1) Increasing dye solubility in non-polar solvents by use of novel dyes.
2) Using multi-component dye dissolution to increase dye solubility.
3) Using a unique combination of dyes to achieve high colour intensity, and a good neutral black

### 1) Increasing Dye Solubility in Non-Polar Solvents by Use of Novel Dyes:

Table 5 shows a large improvement with the hydrocarbon soluble dyes of the invention.

TABLE 5

| | | | | | |
|---|---|---|---|---|---|
| | | Saturation | | | |
| | | concen- | | Wave- | Absorbance at |
| | | tration | | length | wavelength, at 5 |
| Dye | Colour | (%) | Emax | (nm) | micron thickness |

Blue/Cyan Dyes:

| | | | | | |
|---|---|---|---|---|---|
| Oil Blue N | Blue | 0.657 | 14185 | 646 | 0.11399 |
| (commercial) | | | | | |
| S Blue 35 | Blue | 0.385 | 10964 | 648 | 0.044 |
| (commercial) | | | | | |
| Dye 9 | Blue | 4.19 | 15000 | 648 | 0.4425 |
| (Novel) | | | | | |

Red Dyes:

| | | | | | |
|---|---|---|---|---|---|
| Oil Red O | Red | 1.615 | 17972 | 512 | 0.25939 |
| (commercial) | | | | | |
| Solvent Red | Red | 0.6 | 27490 | 516 | 0.15788 |
| 24 | | | | | |
| (commercial) | | | | | |
| Dye 15 | Red | 8.58 | 36000 | 470 | 2.765 |
| (novel) | | | | | |

### 2) Using Multi-Component Dye Dissolution to Increase Dye Solubility.

Whilst a single dye A may have a solubility of A % in a pure hydrocarbon, its solubility in another saturated dye solution (dye B dissolved in hydrocarbon) may be improved since dye A has a diluting affect and acts to reduce the unfavourable interactions between dye B and the solvent. Therefore by using dye homologues in a mixture, one can improve the solubility of each individual component and therefore increase the overall optical density. Examples of this “stabilization by dilution” can be seen in the following tables:

TABLE 6a

| | | | | | Absorbance at |
|---|---|---|---|---|---|
| | | Saturation | | | wavelength, at 5 |
| | | concentration | | Wavelength | micron |
| Dye | Colour | (%) | Emax | (nm) | thickness |
| Oil B N | Blue | 0.657 | 14185 | 646 | 0.0938 |
| Solvent Blue 35 | Blue | 0.385 | 10964 | 646 | 0.0531 |
| Oil B/Solvent Blue 35 | Blue | 1.31 | 12575 | 646 | 0.1816 |

TABLE 6b

| | | | | | Absorbance |
|---|---|---|---|---|---|
| | | | | | at |
| | | Saturation | | | wavelength, |
| | | concentration | | Wavelength | at 5 micron |
| Dye | Colour | (%) | Emax | (nm) | thickness |
| Dye 12 | Yellow | 1.03 | 45000 | 436 | 0.332 |
| Dye 13 | Yellow | 3.72 | 38000 | 416 | 0.915 |
| Dye 12/ | Yellow | 7.61 | 41500 | 420 | 1.87 |
| Dye 13 | | | | | |

TABLE 6c

| | Dye saturation | Dye saturation | Dye saturation |
|---|---|---|---|
| | concentration | concentration % in | concentration |
| | % in | (Decane/dye 12 as | % in (Decane/ |
| Dye name | Decane as solvent | solvent) | dye 2 as solvent) |
| Oil Red O | 1.17 | 1.49 | 1.91 |
| Oil Blue N | 0.62 | 1.14 | 1.34 |
| Solvent Blue | 0.33 | 0.62 | 0.69 |
| 35 | | | |
| Dye 11 | 0.19 | 0.41 | 0.62 |
| Dye 8 | 0.003 | 0.18 | 0.18 |

A mixture of homologues can increase solubility and achieve high optical density without any negative impact on the colour as the dyes have identical chromophores.

TABLE 7

| | | Saturation | | | Absorbance | |
|---|---|---|---|---|---|---|
| | | concen- | | Wave- | (theoretical), | |
| | | tration | | length | at 5 um | Compo- |
| Dye | Colour | (%) | Emax | (nm) | thickness | nents |
| Dye 1a | Black | 1.000 | 44500 | 600 | 0.188 | 1 |
| Dye 2 | Black | 12.934 | 40000 | 599 | 2.527 | 3 |
| Dye 3 | Black | 16.992 | 38500 | 599 | 2.433 | 3 |
| Dye 4 | Black | 17.147 | 34000 | 598 | 2.726 | 3 |
| Dye 5 | Black | 16.233 | 40500 | 598 | 3.067 | 10 |
| Dye 6 | Black | 15.977 | 34000 | 598 | 2.433 | 3 |
| Dye 7 | Black | 15.922 | 45000 | 599 | 3.401 | 3 |

Dye 9 is a homologue mixture of components with identical chromophores to Oil blue N and Solvent Blue 35. An increase in Saturation Concentration and absorbance is shown in the following table:

TABLE 8

| | | Satur- | | | Absorbance | |
|---|---|---|---|---|---|---|
| | | ation | | | (theoret- | |
| | | concen- | | Wave- | ical), | |
| | | tration | | length | at 5 micron | Compo- |
| Dye | Colour | (%) | Emax | (nm) | thickness | nents |
| Oil B N | Blue | 0.66 | 14185 | 646 | 0.0938 | 1 |
| Solvent | Blue | 0.385 | 10964 | 648 | 0.0531 | 1 |
| Blue 35 | | | | | | |
| Oil B/ | Blue | 1.31 | 14185 | 648 | 0.182 | 2 |
| Solvent | | | | | | |
| Blue 35 | | | | | | |
| Dye 9 | Blue | 4.19 | 15000 | 648 | 0.4425 | 6 |

Since the homologues only differ by various long/branch chained solubilising groups, they all have identical absorbance spectrums so the mixture has an effect to increase the amplitude of the whole spectrum. The overall effect of using homologues is a large increase in amplitude of the original spectral absorption, without changing the spectrum of the specially customized single component.

### 3) Using a Combination of Dyes to Achieve High Colour Intensity, and a Good Neutral Black

An important property of the dyes of the invention are their wide absorbance spectrums which allow the formulation of a neutral black dyed fluid not attainable with the sharp peaked CMY dyes. A comparison is made here between a commercially available black, a CMY black and a black according to the invention.

The black mixture described in this invention shows better coverage of the visible spectrum at much higher absorbances.

TABLE 9
Black States

| | | | | Average |
|---|---|---|---|---|
| | | | | Absorbance |
| | Dye/ | | | (visible range) at 5 |
| | Particles | Sat % | Eaverage | micron thickness |
| Commercial | S Black B | 0.723 | 2876.6 | 0.016 |
| Black dye | | | | |
| Mixture of | Dye | 0.02/0.012/ | 12933 | 0.002 |
| single | 8/Dye11/ | 0.011 | | |
| component | Dye12 | | | |
| CMY dyes | | | | |
| Novel | Dye 7/Dye | 18.751/ | 13221 | 1.025 |
| Mixture of | 15/Dye13 | 8.297/2.985 | | |
| this | | | | |
| invention | | | | |

1.-20. (canceled)

21. An electrowetting fluid comprising a solvent or solvent mixture and at least two dyes wherein each comprises at least one chromophoric group and at least one solubilising group and wherein at least two dyes comprise different solubilising groups.

22. The electrowetting fluid according to claim 21, wherein the dyes comprise different hydrocarbon groups.

23. The electrowetting fluid according to claim 22, wherein the hydrocarbon groups are selected from straight chain or branched hydrocarbon groups with at least 4 carbon atoms, optionally substituted with O, S, N or F atoms.

24. The electrowetting fluid according to claim 21, wherein the fluid comprises at least two dyes with homologue solubilising groups.

25. The electrowetting fluid according to claim 21, wherein the fluid comprises at least two dyes with the same chromophoric group.

26. The electrowetting fluid according to claim 21, wherein the fluid comprises at least two dyes with different chromophoric groups.

27. The electrowetting fluid according to claim 21, wherein at least one of the dyes comprises at least two different chromophoric groups.

28. The electrowetting fluid according to claim 21, wherein the fluid comprises at least one black dye and optionally at least one yellow.

29. The electrowetting fluid according to claim 21, wherein the fluid comprises at least one cyan dye, at least one magenta dye and at least one yellow.

30. The electrowetting fluid according to claim 21, wherein it comprises at least one dye according to Formula I, Formula II, Formula III, Formula IV or Formula V 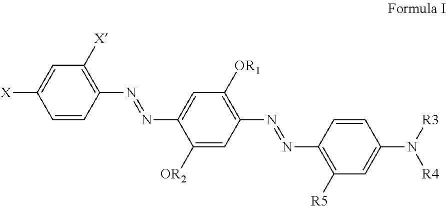
wherein
X and X′ are independently of one another H or an electron-withdrawing group;
R₁ and R₂ are independently of one another groups are linear or branched, substituted or unsubstituted alkyl groups where one or more non-adjacent carbon atoms may be replaced by O, S and/or N;
R3 and R4 are independently of one another groups are linear or branched, substituted or unsubstituted alkyl groups where one or more non-adjacent carbon atoms may be replaced by O, S and/or N;
R5 is a methyl or methoxy group;
and the dye comprises at least one electron-withdrawing group; 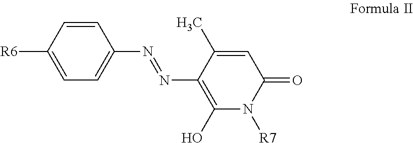
wherein
R₆ and R₇ are independently of one another groups are linear or branched, substituted or unsubstituted alkyl groups where one or more non-adjacent carbon atoms may be replaced by O, S and/or N; 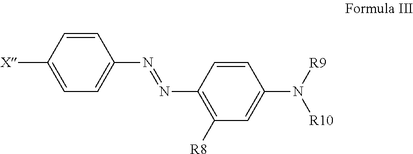
wherein
X″ is an electron-withdrawing group;
R8 is a methyl or methoxy group;
R9 and R10 are independently of one another groups are linear or branched, substituted or unsubstituted alkyl groups where one or more non-adjacent carbon atoms may be replaced by O, S and/or N; 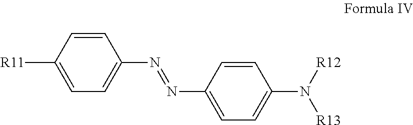
wherein
R12 and R13 are independently of one another groups are linear or branched, substituted or unsubstituted alkyl groups where one or more non-adjacent carbon atoms may be replaced by O, S and/or N;
R11 is an alkyl or alkoxy group with at least 3 carbon atoms; 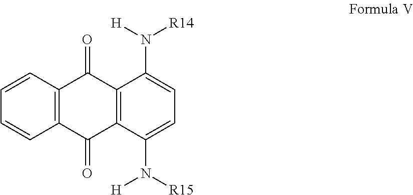
wherein
R14 and R15 are independently of one another groups are linear or branched, substituted or unsubstituted alkyl groups where one or more non-adjacent carbon atoms may be replaced by O, S and/or N; 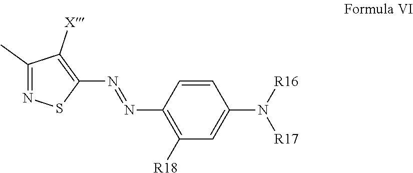
wherein
X′″ is an electron-withdrawing group;
R16 and R17 are independently of one another groups are linear or branched, substituted or unsubstituted alkyl groups where one or more non-adjacent carbon atoms may be replaced by O, S and/or N.
R18 is NHCOR with R=linear or branched C₁-C₁₀ alkyl groups.

31. The electrowetting fluid according to claim 30, wherein dyes of Formula II comprise linear or branched C₈-C₂₀ alkyl groups and optionally additional NO₂ and/or CN groups.

32. The electrowetting fluid according to claim 31, wherein the dyes correspond to Formula IIa

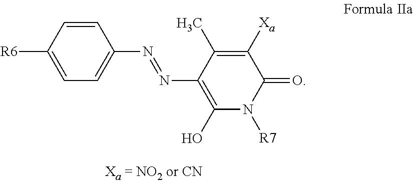

33. The electrowetting fluid according to claim 21, wherein fluid comprises at least one non-polar solvent having a dielectric constant <10, volume resistivity about 10¹⁵ ohm-cm, viscosity <5 cst, and a boiling point >80° C.

34. A method of displaying an image which comprises utilizing the electrowetting fluid according to claim 21.

35. A method for the preparation of a mono, bi or polychromal electrowetting display device which comprises utilizing the electrowetting fluid according to claim 21.

36. An electrowetting display device comprising the electrowetting fluid solution according to claim 21.

37. Electrowetting display device according to claim 36, characterised in that the electrowetting fluid is applied by a technique selected from inkjet printing, slot die spraying, nozzle spraying, and flexographic printing, or any other contact or contactless printing or deposition technique.

38. A dye according to Formula I or Formula II 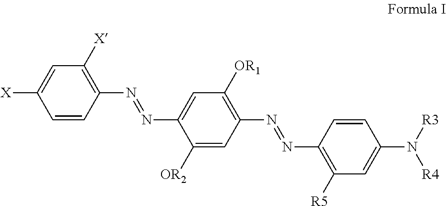
wherein
X and X′ are independently of one another H or an electron-withdrawing group;
R₁ and R₂ are independently of one another groups are linear or branched, substituted or unsubstituted alkyl groups where one or more non-adjacent carbon atoms may be replaced by O, S and/or N;
R3 and R4 are independently of one another groups are linear or branched, substituted or unsubstituted alkyl groups where one or more non-adjacent carbon atoms may be replaced by O, S and/or N;
R5 is a methyl or methoxy group;
and the dye comprises at least one electron-withdrawing group; 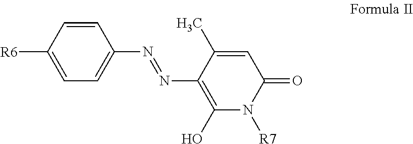
wherein
R6 and R7 are independently of one another groups are linear or branched, substituted or unsubstituted alkyl groups where one or more non-adjacent carbon atoms may be replaced by O, S and/or N.

39. The dye according to claim 38, wherein the dye of Formula II comprises linear or branched C₈-C₂₀ alkyl groups and optionally additional NO₂ and/or CN groups.

40. The dye according to claim 39, wherein the dye correspond to Formula IIa [chemical structure]
